(19) United States
(12) Patent Application Publication
(10) Pub. No.: US 2025/0319446 A1
(43) Pub. Date: Oct. 16, 2025

(54) SEPARATION MEMBRANE, PREPARATION METHOD THEREFOR AND USE THEREOF

(71) Applicants: CHINA PETROLEUM & CHEMICAL CORPORATION, Beijing (CN); SINOPEC (BEIJING) RESEARCH INSTITUTE OF CHEMICAL INDUSTRY CO., LTD., Beijing (CN)

(72) Inventors: Changjiang WU, Beijing (CN); Yang ZHANG, Beijing (CN); Yiqun LIU, Beijing (CN); Guoyuan PAN, Beijing (CN); Hao YU, Beijing (CN); Muhua ZHAO, Beijing (CN); Guoke ZHAO, Beijing (CN); Gongqing TANG, Beijing (CN); Jianhua ZHANG, Beijing (CN); Wenjie DU, Beijing (CN)

(21) Appl. No.: 18/867,607

(22) PCT Filed: May 19, 2023
(86) PCT No.: PCT/CN2023/095323

§ 371 Date: Nov. 20, 2024

(30) Foreign Application Priority Data
May 20, 2022 (CN) 202210555981.0

(51) Int. Cl. B01D 71/60; B01D 67/00; B01D 69/10; B01D 69/12; B01D 71/48

(52) U.S. Cl. CPC B01D 71/60; B01D 67/0006; B01D 69/1071; B01D 69/1216; B01D 71/48; B01D 2323/30; B01D 2325/02831; B01D 2325/04; B01D 2325/26

(57) ABSTRACT

A separation membrane, a preparation method therefor and a use thereof in magnesium and lithium separation are provided. The separation membrane includes, in sequence, a base material layer, a porous support layer, a polyamide layer and a modification layer. Cross-linked polymers forming the modification layer has structural units provided by polyphenols and polyamines, at least some of the structural units provided by the polyphenols are connected to the polyamide layer via ortho positions of phenolic hydroxyl groups. The preparation method includes sequentially preparing the porous support layer, the polyamide layer and the modification layer on the base material layer. The method of preparing the modification layer includes under a first pressure, bringing one side of the polyamide layer into first contact with the polyphenol solution; then under a second pressure, bringing one side of the polyamide layer into second contact with the polyamine solution, to complete a self-assembly reaction.

### CROSS-REFERENCE TO RELATED APPLICATIONS

The application claims the benefit of the Chinese patent application No. “202210555981.0”, filed on May 20, 2022, entitled “SEPARATION MEMBRANE, PREPARATION METHOD THEREFOR AND USE THEREOF”, the content of which is specifically and entirely incorporated herein by reference.

### TECHNICAL FIELD

The invention relates to the field of membranes, in particular to a separation membrane and a preparation method therefor and use thereof.

### BACKGROUND ART

The demand for lithium energy has been gradually increasing along with the widespread use of new energy vehicles. Most of the lithium resources in China are stored in salt lake brine. Besides lithium ions, salt lake water contains a large amount of magnesium ions and sodium ions, and the extraction of pure lithium resources from the salt lake water suffers from high technical difficulty. Researchers have developed a series of methods and processes (e.g., precipitation method, solar pond method, extraction method, calcination method, membrane separation method, and adsorption method) to obtain lithium resources. Among them, the membrane separation method and the adsorption method are the most widely researched.

However, the existing commercial nanofiltration membrane is not designed for magnesium-lithium separation, the membrane has an extremely low separation efficiency for the magnesium ions and lithium ions, and the coefficient of magnesium-lithium separation is generally less than 5, thus the existing commercial nanofiltration membrane cannot be used for extracting lithium from salt lake water. Therefore, how to achieve an efficient magnesium-lithium separation is still confronted with many challenges.

### SUMMARY OF THE INVENTION

The present invention aims to overcome the above defects in the prior art and provides a separation membrane, a preparation method, and use thereof, wherein the separation membrane has a high compactness and a high surface electrode potential (Zeta potential), can desirably intercept magnesium ions during its use for magnesium-lithium separation, thereby obtaining the high magnesium-lithium separation efficiency, and the separation membrane has a high water flux and a higher treatment efficiency.

In order to fulfill the above purpose, the first aspect of the present invention discloses a separation membrane comprising a base material layer, a porous support layer, a polyamide layer, and a modification layer in sequence;

wherein the cross-linked polymers forming the modification layer comprise structural units provided by polyphenols and structural units provided by polyamines, at least some of the structural units provided by the polyphenols connecting with the polyamide layer via ortho-positions of phenolic hydroxyl groups;

wherein a pore size of the separation membrane is within the range of 0.1-0.5 nm, and a surface Zeta potential of the separation membrane is within the range from −5 mV to 30 mV.

In the second aspect, the present invention discloses a method for preparing the separation membrane comprising: sequentially preparing the porous support layer, the polyamide layer, and the modification layer on the base material layer;
wherein a method for preparing the modification layer comprising: under a first pressure, and under conditions in which a polyphenol solution remains fluid, subjecting the polyamide layer side of a material comprising a base material layer, a porous support layer and a polyamide layer to a first contact with the polyphenol solution; then under a second pressure, and under conditions in which a polyamine solution remains fluid, subjecting the polyamide layer side of the material to a second contact with the polyamine solution to complete a self-assembly reaction.

The third aspect of the present invention discloses a separation membrane prepared with the aforementioned method.

The fourth aspect of the present invention discloses a use of the separation membrane according to the first aspect or the third aspect in the magnesium-lithium segmentation.

The separation membrane provided by the present invention has a high compactness and a high surface electrode potential (Zeta potential), can desirably intercept magnesium ions during its use for the magnesium-lithium separation, and lithium ions can pass through the separation membrane as much as possible, thereby obtaining the high magnesium-lithium separation efficiency, and the separation membrane has a high water flux and a higher treatment efficiency.

In the method for preparing the separation membrane provided by the invention, under the conditions consisting of a first pressure and a second pressure, and keeping the fluid state of the polyphenol solution and the polyamine solution, the separation membrane comprising a modification layer can be prepared through the self-assembly reaction of polyamines and polyphenols on the polyamide layer, such that the prepared separation membrane has high compactness and a high surface electrode potential (Zeta potential), can desirably intercept magnesium ions during its use for the magnesium-lithium separation, and lithium ions can pass through the separation membrane as much as possible, thereby obtaining the high magnesium-lithium separation efficiency, and the separation membrane has a high water flux and a higher treatment efficiency. In addition, the preparation method has a simple process and vast industrialization prospects.

### BRIEF DESCRIPTION OF THE DRAWINGS

FIG. 1 illustrates the infrared spectrograms of the separation membranes prepared in Example 1 and Comparative Examples 1-2 of the present invention respectively.

FIG. 2 illustrates a variation curve of the surface Zeta potential of the separation membrane relative to the number of self-assembly processes;

FIG. 3 illustrates a variation curve of the surface Zeta potential of the separation membrane relative to the self-assembly pressure (first pressure/second pressure);

FIG. 4 illustrates a variation curve of the contact angle of the separation membrane relative to the self-assembly pressure (first pressure/second pressure);

FIG. 5 illustrates a variation curve of the contact angle of the separation membrane relative to the number of self-assembly processes;

FIG. 6 illustrates a cross-sectional scanning electron microscope (SEM) graph of the separation membranes prepared in Comparative Example 1 (FIG. 6a) and Example 10 (FIG. 6b);

FIG. 7 illustrates the X-ray photoelectron spectroscopy (XPS) nitrogen element charts of the separation membranes prepared in Example 1 and Comparative Example 6.

### DESCRIPTION OF REFERENCE SIGNS

1—Modification layer; 2—Polyamide layer; 3—Porous support layer.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined to produce one or more new numerical ranges, which should be deemed have been specifically disclosed herein.

In the first aspect, the present invention discloses a separation membrane comprising a base material layer, a porous support layer, a polyamide layer, and a modification layer in sequence;
wherein the cross-linked polymers forming the modification layer comprise structural units provided by polyphenols and structural units provided by polyamines, at least some of the structural units provided by the polyphenols connecting with the polyamide layer via ortho-positions of phenolic hydroxyl groups;
wherein a pore size of the separation membrane is within the range of 0.1-0.5 nm, and a surface Zeta potential of the separation membrane is within the range from −5 mV to 30 mV.

The present inventors have discovered in research that the separation membrane comprises a modification layer as described above, so the separation membrane has a pore size range and a surface Zeta potential range as described in the present invention, which indicates that the separation membrane has high compactness and a high surface electrode potential, and when the separation membrane is used for lithium-magnesium separation, it can desirably repel divalent magnesium ions, so that the magnesium ions in the liquid cannot easily pass through the separation membrane, and allows the monovalent lithium ions to pass through as much as possible, thereby obtaining the high magnesium-lithium separation efficiency. In addition, due to the synergy of the layers, the separation membrane has a high water flux and can have a higher treatment efficiency when the membrane is applied in the magnesium-lithium separation in a liquid.

In the present invention, the pore size of the separation membrane is measured by using a polyethylene glycol (PEG) solute transfer method, which comprises the detailed steps as follows:
(1) testing a retention rate of the separation membrane regarding PEG with different molecular sizes;
(2) the PEG size and the retention rate are linearly fitted in a log-probability coordinate system, and the PEG size corresponding to the 50% retention rate is the average pore size of the separation membrane.

In the present invention, the surface Zeta potential of the separation membrane is measured through a potentiometric analyzer.

Further, the pore size of the separation membrane is within the range of 0.15-0.3 nm, and the surface Zeta potential of the separation membrane within the range from 1 mV to 10 mV.

According to the present invention, the modification layer comprises the structural units shown in formula I;

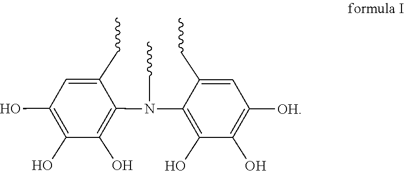

The present inventors have discovered in researches that when XPS is used for testing nitrogen element in a modification layer of the separation membrane, the modification layer of the separation membrane provided by the present invention comprises structure units shown in formula I, that is, π-π* electron conjugate structure units formed by benzene ring-nitrogen atom-benzene ring exist in the modification layer, it further demonstrates that at least part of structure units from polyphenols in the modification layer are subjected to a crosslinking reaction with the structure units from polyamines and/or the nitrogen atoms from the polyamide layer through the ortho-positions of phenolic hydroxyl groups, so that the pore size of the separation membrane comprising the modification layer is further reduced, the compactness degree of the separation membrane is further improved, thereby improving the magnesium-lithium separation efficiency when the separation membrane is used for the magnesium-lithium separation.

According to the present invention, a content of the structural units provided by polyphenols at the membrane surface is within the range of 2×10⁻³-5×10⁻² mg/cm², a content of the structural units provided by polyamines at the membrane surface is within the range of 1×10⁻³-2.5×10⁻² mg/cm².

In the separation membrane, the content of structural units provided by polyphenols and structural units provided by polyamines on the membrane surface of the separation membrane is measured according to the following steps:
drying a membrane comprising a base material layer, a porous support layer and a polyamide layer in a vacuum oven at 60° C. for 24 hours, then weighting the mass of the membrane to be Mₙ, in the unit of mg; putting the membrane into a membrane pool, wherein a feeding tank contains an aqueous solution of polyphenols with a certain concentration, after circulating for a certain time under a certain condition, taking out the membrane, washing the surface of the membrane with deionized water, drying at 60° C. for 24 hours, and weighting the mass of the membrane as Wₙ, in the unit of mg; again putting the membrane into a membrane pool, wherein a feeding tank contains an aqueous solution of polyamines with a certain concentration, after circulating for a certain time under a certain condition, taking out the membrane, washing the surface of the membrane with deionized water, drying at 60° C. for 24 hours, and weighting the mass of the membrane as Nₙ, in the unit of mg; the content Pₙ of polyphenols and the content Tₙ of polyamines on the surface of the membrane in each modification of the separation membrane are respectively calculated with the following formulas:

$$Pn = \frac{Wn - Mn}{S} ;$$

wherein, when n is greater than 1, Mₙ=Nₙ₋₁; when n=1, Mₙ is the original mass of the polyamide membrane;

$$Tn = \frac{Nn - Wn}{S} ;$$

after the separation membrane is subjected to self-assembly, the total content of polyphenols on the surface is denoted as ΣPₙ, wherein n is more than or equal to 1; the total content of polyamines on the surface is denoted as ΣTₙ, wherein n is more than or equal to 1;
wherein n denotes the number of self-assembly reactions, S denotes the effective membrane area, in the unit of cm².

In the present invention, the inventors have studied and found that when the content of structural units provided by polyphenols and structural units provided by polyamines on the surface of the membrane falls into the above range, the separation membrane has a suitable compactness degree and thickness, thereby ensuring that the separation membrane has a high magnesium-lithium separation coefficient and water flux.

Further, the content of the structural units provided by polyphenols at the membrane surface is within the range of 2.5×10⁻³-5×10⁻² mg/cm²; the content of the structural units provided by polyamines at the membrane surface is within the range of 4×10⁻³-2×10⁻² mg/cm².

According to the present invention, a content of nitrogen (N) atoms in the modification layer is within the range of 13-20 at. %.

In the present invention, a content of N atoms in the modification layer is measured by an X-ray photoelectron spectroscopy analyzer.

In the present invention, when the content of N atoms in the modification layer falls into the above range, the separation membrane has high surface electrode potential and excellent hydrophilicity, and when it is used for the magnesium-lithium separation, it has high magnesium-lithium separation efficiency and high water flux.

Further, the content of N atoms in the modification layer is within the range of 13.5-18.5 at. %. According to the invention, a contact angle of the separation membrane is within the range of 20-60°. In the present invention, a contact angle of the separation membrane is measured according to the following method: the DSA100 type surface contact angle measuring instrument produced by the German KRUSS Company is used for testing the surface contact angle of a composite membrane sample through the sessile drop method, before the testing, the sample is dried in a vacuum oven at 60° C. for 30 min to remove moisture on the surface and inside the sample, a dried membrane is then pasted on a flat glass slide by a double-sided adhesive tape; the volume of each water drop is 2 μL during testing; the water drop is immediately tested after being dropped on the surface of the membrane for 3 s; and the size of the final contact angle is determined by measuring for many times and averaging the measurement results.

The separation membrane has a contact angle within the range described in the present invention, thereby showing that the separation membrane has excellent hydrophilicity, enabling the separation membrane to have excellent water permeability.

Further, the contact angle of the separation membrane is within the range of 20-40°.

According to the present invention, the separation membrane preferably has a thickness within the range of 100-200 μm.

According to the present invention, the base material layer preferably has a thickness within the range of 30-150 μm, more preferably within the range of 50-120 μm.

According to the present invention, the porous support layer preferably has a thickness within the range of 10-100 μm, more preferably within the range of 30-60 μm.

According to the present invention, the polyamine layer preferably has a thickness within the range of 10-500 nm, more preferably within the range of 50-150 nm.

According to the present invention, the modification layer preferably has a thickness within the range of 1-200 nm, more preferably within the range of 10-60 nm.

In the present invention, the thicknesses of the separation membrane, the porous support layer, and the polyamide layer are measured by a micrometer caliper and a scanning electron microscope (SEM); and the thickness of the modification layer is obtained by subtracting the thicknesses of the base material layer, the porous support layer and the polyamide layer from the thickness of the separation membrane. Wherein the thickness of the base material layer is exactly the thickness measured before coating the porous support layer material solution.

The inventors of the present invention have found in research that, when the thickness ranges of the above layers are satisfied, the layers can produce a synergy, so that the separation membrane has a small pore size and a high Zeta potential, and when the separation membrane is used in the magnesium-lithium separation, it can obtain both the higher magnesium-lithium separation efficiency and higher water flux.

According to the present invention, the base material layer material is not particularly limited, it can be a commonly used material in the field that has a certain strength, is suitable for nanofiltration or reverse osmosis, and can play a supporting role. However, a material of the base material layer is preferably at least one selected from the group consisting of a polyester nonwoven fabric, a polyethylene nonwoven fabric, and a polypropylene nonwoven fabric.

According to the present invention, the porous support layer material is not particularly limited and may be a material that can exert a certain supporting function and can form a porous structure, which is commonly used in the art. More preferably, a material of the porous support layer is at least one selected from the group consisting of polyether sulfone, polysulfone, polyaromatic ether, polybenzimidazole, polyether ketone, polyether ether ketone, polyacrylonitrile, polyvinylidene fluoride, and polyaryletherketone. The porous structure in the porous support layer enables liquid to easily flow through the porous structure. The number average molecular weight of the porous support layer material may be within the range of 50,000-100,000 g/mol.

According to the present invention, the polyamide layer is preferably produced from the synthesis of polyamines and polyacyl chloride.

In the present invention, the polyamide layer has a more suitable cross-linked structure, in combination with the amino group contained therein, the divalent magnesium ions can be favorably intercepted.

Further, the polyamines are at least one selected from the group consisting of polyethyleneimine, triethylene tetramine, tetraethylene pentamine, diethylene triamine, piperazine, m-phenylenediamine, and p-phenylenediamine, more preferably at least one of polyethyleneimine, piperazine, and polyethylene polyamine.

Further, the polyacyl chloride is at least one selected from the group consisting of trimesoyl chloride, terephthaloyl chloride, isophthaloyl chloride, and phthaloyl chloride, and more preferably at least one of trimesoyl chloride and terephthaloyl chloride. When the polyacyl chloride is composed of a plurality of ingredients, the specific species of the polyacyl chlorides can be blended according to any proportion, for example, when the polyacyl chlorides consist of trimesoyl chloride and terephthaloyl chloride, the weight ratio of the trimesoyl chloride to the terephthaloyl chloride may be within the range of 1: (1-10).

According to the present invention, the modification layer is obtained through a self-assembly reaction of polyphenols and polyamines on a polyamide layer.

In the present invention, the self-assembly reaction comprises the following steps: under a first pressure, and under conditions in which a polyphenol solution remains fluid, subjecting the polyamide layer side of a material comprising a base material layer, a porous support layer and a polyamide layer to a first contact with the polyphenol solution; then under a second pressure, and under conditions in which a polyamine solution remains fluid, subjecting the polyamide layer side of the material to a second contact with the polyamine solution to complete a self-assembly reaction.

According to the present invention, the polyphenols are one or more selected from the group consisting of tannic acid, tea polyphenol, gallic acid, catechuic acid, lignin, sodium lignosulfonate, apple polyphenol, grape polyphenol, eriodictyol, naringenin, epicatechin, luteolin, apigenin, kaempferol, myricetin, and genistein, more preferably tannic acid and/or tea polyphenol.

According to the present invention, the polyamines are at least one selected from the group consisting of polyethyleneimine, tetraethylene pentamine, triethylene tetramine, and polyethylene polyamine.

According to the present invention, the first pressure and the second pressure are each independently within the range of 0.1-1.2 MPa.

In the present invention, when the pressure applied during the preparation of the modification layer is controlled to satisfy the above range, it is possible to ensure that the separation layer composed of the modification layer and the polyamide layer has a high compactness degree, and the separation membrane has a high content of structural units provided by the polyamines, so that the separation membrane has high hydrophilicity, and finally the separation membrane has excellent magnesium-lithium separation performance and water permeability.

Further, the first pressure and the second pressure are each independently within the range of 0.2-1 MPa.

In the present invention, the polyphenol solution and the polyamine solution are used in an amount such that a mass ratio of the polyphenols to the polyamines is within the range of (0.1-10): 1.

In the present invention, when the mass ratio of the polyphenols to the polyamines is controlled to satisfy the above range, it is ensured that the polyphenols and the polyamines can react sufficiently, the prepared separation membrane has the pore size required by the present invention, and it is also ensured that the surface of the separation membrane contains more residual amino groups, so that the separation membrane has the high surface Zeta potential and hydrophilicity required by the invention; when the separation membrane is used in the magnesium-lithium separation, the separation membrane has higher interception rate of the divalent magnesium ions and the higher water flux.

Further, the polyphenol solution and the polyamine solution are used in an amount such that a mass ratio of the polyphenols to the polyamines is within the range of (0.2-6): 1, preferably within the range of (0.5-6): 1.

In the present invention, a concentration of the polyphenol solution is within the range of 0.00001-1 wt %, preferably within the range of 0.0001-0.1 wt %.

In the present invention, a concentration of the polyamine solution is within the range of 0.00001-1 wt %, preferably within the range of 0.0001-0.1 wt %.

In the present invention, a concentrations of the polyphenol solution and the polyamine solution are independently controlled to satisfy the above ranges, so that it can ensure that the prepared separation membrane has the pore size, surface Zeta potential, and thickness required in the present invention, and when the separation membrane is used in magnesium-lithium separation, the interception rate of magnesium chloride is improved while maintaining the desirable water permeability.

In the present invention, the temperatures of the first contact and the second contact are each independently within the range of 10-30° C.

In the present invention, when the temperatures of the first contact and the second contact are controlled to satisfy the above range, it can ensure that the reaction between polyphenols and polyamines is sufficiently implemented, so that the prepared separation membrane has the pore size and surface Zeta potential required by the present invention, thereby improving the magnesium chloride interception rate and magnesium-lithium separation efficiency of the separation membrane during its use for the magnesium-lithium separation.

In the present invention, in one self-assembly reaction, time of the first contact is within the range of 1-120 min.

In the present invention, in one self-assembly reaction, time of the second contact is within the range of 1-120 min.

In the present invention, when the time for the first contact and the second contact in one self-assembly reaction is controlled to satisfy the above range, it not only can ensure that a sufficient reaction between polyphenols and the polyamines is performed, but also can ensure that the compactness degree and thickness of the membrane separation layer composed of the polyamide layer and the modification layer can be properly controlled, and finally, the prepared separation membrane has high water permeability and magnesium-lithium separation performance.

Further, in one self-assembly reaction, time of the first contact is within the range of 10-60 min.

Further, in one self-assembly reaction, time of the second contact is within the range of 10-60 min. The present inventors further discover in the research that when the following steps are repeated according to the method for preparing the modification layer on the polyamide layer of a material comprising the base material layer, the porous support layer, and the polyamide layer, and the self-assembly is completed for many times, it can ensure that the separation membrane has higher surface Zeta potential and smaller pore size, thereby further ensuring to obtain higher magnesium-lithium separation efficiency. Specifically, number of self-assembly reactions is within the range of 1-10, more preferably within the range of 2-5.

In a preferred embodiment of the present invention, the water flux of the separation membrane is larger than or equal to 20 L·m⁻²·h⁻¹; the desalinization rate of MgCl₂ is more than or equal to 99%; the magnesium-lithium separation coefficient is larger than or equal to 70.

In a more preferred embodiment of the present invention, the water flux of the separation membrane is within the range of 20-40 L·m⁻²·h⁻¹; the desalinization rate of MgCl₂ is more than or equal to 99%; the magnesium-lithium separation coefficient is within the range of 100-250.

In the second aspect, the present invention discloses a method for preparing the separation membrane comprising: sequentially preparing the porous support layer, the polyamide layer, and the modification layer on the base material layer;
wherein a method for preparing the modification layer comprising: under a first pressure, and under conditions in which a polyphenol solution remains fluid, subjecting the polyamide layer side of a material comprising a base material layer, a porous support layer and a polyamide layer to a first contact with the polyphenol solution; then under a second pressure, and under conditions in which a polyamine solution remains fluid, subjecting the polyamide layer side of the material to a second contact with the polyamine solution to complete a self-assembly reaction.

In the present invention, the polyphenols and the polyamines may carry out the Michael addition reaction to form a cross-linked structure. The carbon atoms at ortho-positions of the carbon atom of phenyl hydroxyl groups on polyphenols are used as the reaction sites to react with polyamines. When reacting on the surface of the polyamide layer, the carbon atoms at ortho-positions of the carbon atom of phenyl hydroxyl groups on polyphenols are used as the reaction sites to react with the amino group in the polyamide layer.

In the present invention, the separation membrane is prepared according to the method provided by the second aspect of the present invention, under the first pressure and the second pressure, and under the condition that the polyphenol solution and the polyamine solution remain fluid, subjecting the polyamide layer side of a material comprising a base material layer, a porous support layer and a polyamide layer to contact and reaction with the polyphenol solution and the polyamine solution sequentially, the polyphenols and the polyamines can carry out the Michael addition reaction on the surface of the polyamide layer to form a cross-linked structure, and the carbon atoms at ortho-positions of the carbon atom of part of phenyl hydroxyl groups on polyphenols may react with an amino group in the polyamide layer, and connect with the polyamide layer.

Meanwhile, under the action of the first pressure and the second pressure and the conditions that the polyphenol solution and the polyamine solution remain fluid, the prepared separation membrane can have small pore size and high surface Zeta potential, that is, the separation membrane according to the first aspect of the present invention is prepared. Specifically in the present invention, the self-assembly reaction process is controlled to be carried out in a dynamic environment with a certain flow rate, so that the purpose of reducing the adsorption of extra polyphenols or polyamine on the membrane surface can be achieved, and more polyphenols or polyamines can be bonded to the membrane surface through chemical bonds. Finally, after the separation membrane is subjected to self-assembly modification, the separation membrane has significantly increased compactness degree and high surface Zeta potential.

The separation membrane prepared with the method disclosed by the second aspect of the present invention has the pore size range and the surface Zeta potential range of the present invention, which indicates that the separation membrane has a high compactness and a high surface electrode potential, and when the separation membrane is used for magnesium-lithium separation, it can desirably repel divalent magnesium ions, so that the magnesium ions in the liquid cannot easily pass through the separation membrane, and allows the monovalent lithium ions to pass through as much as possible, thereby obtaining the high magnesium-lithium separation efficiency. In addition, due to the synergy of the layers, the separation membrane has a high water flux and can have a higher treatment efficiency when the membrane is applied in the magnesium-lithium separation in a liquid.

According to the present invention, the first pressure and the second pressure are each independently within the range of 0.1-1.2 MPa.

In the present invention, when the first pressure and the second pressure are independently controlled to satisfy the above ranges during the process of preparing the modification layer, the reaction of polyphenols with polyamines can be performed more sufficiently, and the prepared separation membrane has the pore size and surface Zeta potential required in the present invention; when the prepared separation membrane is used in the magnesium-lithium separation, the separation membrane has high magnesium chloride interception rate and excellent magnesium-lithium separation efficiency.

Further, the first pressure and the second pressure are each independently within the range of 0.2-1 MPa.

In the present invention, the self-assembly reaction may be carried out in a cross-flow membrane pool, the cross-flow membrane pool uses a water pump to pump water into the membrane pool in a circulating manner, so that water in the membrane pool is flowing, and a pressure is applied through a pressure regulating valve, such that the first pressure and the second pressure in the preparation process are controlled to meet the requirements of the present invention.

In the present invention, the method for preparing the modification layer may be implemented in conventional equipment in the field, such as a cross-flow membrane pool, and the method has a simple process and can be easily industrialized. During the self-assembly reaction in the cross-flow membrane pool, for example, after the polyphenols are in contact with the material, the polyphenol solution is discharged, and deionized water is used to repeatedly wash the cross-flow membrane pool to clean the polyphenols in the system, and also wash out the polyphenols on the surface of the material.

In the present invention, the pump continuously conveys the solution to the cross-flow membrane pool, so the total amount of polyphenols or polyamines in the solution generally exceeds the amount of polyphenols or polyamines attached to the membrane surface for reaction, it can ensure that the modification layer required by the present invention is obtained. In the present invention, the flow rates of the polyphenol solution and the polyamine solution are not particularly limited as long as it is ensured that the polyphenol solution and the polyamine solution are kept flowing during the preparation of the modification layer, for example, the flow rate of the polyphenol solution or the polyamine solution may be within the range of 0.5-5 L/min.

According to the present invention, the polyphenol solution and the polyamine solution are used in an amount such that a mass ratio of the polyphenols to the polyamines is within the range of (0.1-10): 1.

In the present invention, when the mass ratio of the polyphenols to the polyamines is controlled to satisfy the above range, it is ensured that the polyphenols and the polyamines are reacted sufficiently, the prepared separation membrane has the pore size required by the present invention, and it can also be ensured that the surface of the separation membrane contains more residual amino groups, so that the separation membrane has the high surface Zeta potential and hydrophilicity required by the present invention, and when the separation membrane is used in the magnesium-lithium separation, the separation membrane has higher interception rate of divalent magnesium ions and higher water flux.

Further, the polyphenol solution and the polyamine solution are used in an amount such that a mass ratio of the polyphenols to the polyamines is within the range of (0.2-6): 1, more preferably within the range of (0.5-6): 1.

According to the present invention, a concentration of the polyphenol solution is within the range of 0.00001-1 wt %, preferably within the range of 0.0001-0.1 wt %.

According to the present invention, a concentration of the polyamine solution is within the range of 0.00001-1 wt %, preferably within the range of 0.0001-0.1 wt %.

In the present invention, the concentrations of the polyphenol solution and the polyamine solution are independently controlled to satisfy the above ranges, it can ensure that the prepared separation membrane has the pore size, surface Zeta potential, and thickness required by the present invention, and when the separation membrane is used in magnesium-lithium separation, the separation membrane can maintain desirable water permeability while improving the interception rate of magnesium chloride.

According to the present invention, temperatures of the first contact and the second contact are each independently within the range of 10-30° C.

In the present invention, when temperature of the first contact and the second contact are controlled to satisfy the above range, it can ensure that a sufficient reaction between polyphenols and the polyamines is performed, so that the prepared separation membrane has the pore size and surface Zeta potential required by the present invention, thereby improving the interception rate of magnesium chloride and the magnesium-lithium separation efficiency of the separation membrane when it is used for magnesium-lithium separation.

According to the present invention, in one self-assembly reaction, time of the first contact is within the range of 1-120 min.

According to the present invention, in one self-assembly reaction, time of the second contact is within the range of 1-120 min.

In the present invention, when the time for the first contact and the second contact in one self-assembly reaction is controlled to satisfy the above range, it not only can ensure that a sufficient reaction between polyphenols and the polyamines is performed, but also can ensure that the compactness degree and thickness of the membrane separation layer composed of the polyamine layer and the modification layer can be properly controlled, and finally, the prepared separation membrane has high water permeability and magnesium-lithium separation performance.

Further, in one self-assembly reaction, time of the first contact is within the range of 10-60 min.

Further, in one self-assembly reaction, time of the second contact is within the range of 10-60 min. In the present invention, the inventors further discovered in the research that when the following steps are repeated according to the method for preparing the modification layer on the polyamide layer of a material comprising the base material layer, the porous support layer, and the polyamide layer, and the self-assembly is completed for many times, it can ensure that the separation membrane has higher surface Zeta potential and smaller pore size, thereby further ensuring to obtain higher magnesium-lithium separation efficiency. Specifically, number of self-assembly reactions is within the range of 1-10, more preferably within the range of 2-5.

According to the present invention, conditions for preparing the modification layer are such that the thickness of the modification layer in the separation membrane is within the range of 1-200 nm, preferably within the range of 10-60 nm.

According to the present invention, polyphenols in the polyphenol solution are one or more selected from the group consisting of tannic acid, tea polyphenol, gallic acid, catechuic acid, lignin, sodium lignosulfonate, apple polyphenol, grape polyphenol, eriodictyol, naringenin, epicatechin, luteolin, apigenin, kaempferol, myricetin, and genistein, more preferably tannic acid and/or tea polyphenol.

According to the present invention, polyamines in the polyamine solution are at least one selected from the group consisting of polyethyleneimine, tetraethylene pentamine, triethylene tetramine, and polyethylene polyamine.

In the present invention, the method of preparing the porous support layer on the base material layer may be a method commonly used in the art. Preferably, the method for preparing the porous support layer comprising: coating a solution containing the porous support layer material on a base material layer, and performing a phase transformation to obtain a material containing the base material layer and the porous support layer.

In the present invention, the specific manner of coating is not particularly limited, and the coating may be performed using a scraper.

According to the present invention, conditions for the phase transformation include: soaking in water of 10-30° C. for 10-60 min.

In the present invention, when the method for preparing a porous support layer as described above is adopted, the solvent in the solution containing the porous support layer material gradually leaves the porous support layer upon immersion in water, through using the phase transformation method, it is further ensured to obtain a support layer having a porous structure.

According to the present invention, the thickness of the base material layer is preferably within the range of 30-150 μm, more preferably within the range of 50-120 μm. It can be understood that the thickness of the base material layer does not substantially change before and after the preparation.

In the present invention, the base material layer material is at least one selected from the group consisting of a polyester nonwoven fabric, a polyethylene nonwoven fabric, and a polypropylene nonwoven fabric.

According to the present invention, conditions for preparing the porous support layer include such that a thickness of the porous support layer in the separation membrane is preferably within the range of 10-100 μm, more preferably within the range of 30-60 μm. It can be comprehended that the thickness may be controlled by controlling the coating amount, given that the collapse of the thickness occurs after the coating process, the thickness set during the coating process may be somewhat different from the thickness of the porous support layer in the finally prepared separation membrane. Generally, the thickness set during the coating process is about 40-60 μm higher than the desired thickness of the porous support layer in the separation membrane.

According to the present invention, the concentration of the solution containing the porous support layer material is within the range of 10-20 wt %.

According to the present invention, the porous support layer material is at least one selected from the group consisting of polyether sulfone, polysulfone, polyaromatic ether, polybenzimidazole, polyether ketone, polyether ether ketone, polyacrylonitrile, polyvinylidene fluoride, and polyaryletherketone.

According to the present invention, the solvent in the solution comprising the porous support layer material is at least one selected from the group consisting of N,N-dimethylformamide, N,N-dimethylacetamide, N-methylpyrrolidone, and dimethylsulfoxide.

In the present invention, the method for preparing the solution containing the porous support layer material is not particularly limited and can be prepared with the conventional method in the art, for example, the porous support layer material is initially dissolved in a solvent, the defoaming is then performed (defoaming can be performed at 20-40° C. for 10-180 min), such that a solution containing the porous support layer material is obtained.

It is preferable in the present invention that after the porous support layer is prepared, the material may be washed, such as being washed with water several times.

According to the present invention, the method for preparing the polyamine layer comprising: subjecting a porous support layer surface of a material comprising the base material layer and the porous support layer sequentially with an aqueous phase comprising polyamines and an organic phase comprising polyacyl chloride, then performing a thermal treatment.

In the present invention, by adopting the method of contacting the porous support layer with an aqueous phase comprising polyamines and an organic phase comprising polyacyl chloride sequentially, the polyamide layer is obtained through interfacial polymerization, such that the prepared polyamide layer has a cross-linked structure, the polyamide layer is not only compact but also very thin, it further ensures the high magnesium-lithium separation efficiency and high water flux. Wherein the operation of contacting with the aqueous phase and the organic phase may be carried out under the normal temperature, for example, the temperature of 23-28° C.

According to the present invention, conditions for preparing the polyamine layer include such that the thickness of the polyamine layer in the separation membrane is within the range of 10-500 nm, preferably within the range of 50-300 nm.

According to the present invention, time of contacting the porous support layer surface with an aqueous phase comprising polyamines is preferably within the range of 5-100 s, more preferably within the range of 10-60 s.

According to the present invention, time of contacting the porous support layer with an organic phase comprising polyacyl chloride is within the range of 10-200 s, preferably within the range of 20-120 s.

According to the present invention, the aqueous phase comprising polyamines and the organic phase comprising the polyacyl chloride are used in an amount such that the mass ratio of the polyamines to the polyacyl chloride is within the range of (0.1-10): 1.

The present inventors have also discovered that when the mass ratio of polyamines to polyacyl chloride is controlled to satisfy the above ratio, it can ensure that the resulting polyamide layer has a suitable pore size, the polyamide layer has excellent lithium chloride permeability and a desirable interception regarding magnesium chloride; meanwhile, after the polyamine layer is modified with polyphenols and polyamines, the pore size of the polyamine layer can be further reduced, the surface Zeta potential can be further improved, and the separation membrane with the specific pore size and surface Zeta potential defined in the first aspect of the present invention can be finally prepared; when the separation membrane is used for magnesium-lithium separation, it exhibits the significantly improved magnesium-lithium separation efficiency.

Further, the aqueous phase comprising polyamines and the organic phase comprising the polyacyl chloride are used in an amount such that the mass ratio of the polyamines to the polyacyl chloride is within the range of (0.5-8): 1.

In the present invention, the organic solvent in the organic phase containing the polyacyl chloride may be at least one selected from the group consisting of n-hexane, dodecane, n-heptane, and alkane solvent oils (commercially available Isopar E, Isopar G, Isopar H, Isopar L, and Isopar M).

According to the present invention, a concentration of the aqueous phase comprising polyamines is within the range of 0.1-10 wt %, more preferably within the range of 0.5-2.5 wt %.

According to the present invention, a concentration of the organic phase comprising polyacyl chloride is within the range of 0.01-1 wt %, more preferably within the range of 0.1-0.5 wt %. When the polyacyl chloride is composed of a plurality of ingredients, the specific species of the polyacyl chlorides can be mixed in any proportion, for example, when the polyacyl chlorides are composed of trimesoyl chloride and terephthaloyl chloride, mass ratio of the trimesoyl chloride to the terephthaloyl chloride may be within the range of 1: (1-10).

In the present invention, the thickness of the prepared polyamide layer is within the range of 10-500 nm by controlling the concentrations of the aqueous phase comprising polyamines and an organic phase comprising polyacyl chloride, the contact time of the porous support layer with the aqueous phase comprising polyamines and an organic phase comprising polyacyl chloride, and the mass ratio of the polyamines to the polyacyl chloride to satisfy the above ranges.

Further in the present invention, when the concentrations of the aqueous phase comprising polyamines and an organic phase comprising polyacyl chloride are controlled to satisfy the ranges defined in the present invention, the separation membrane has a higher interception rate for magnesium ions and higher permeability for monovalent lithium ions.

In the present invention, the volume of an aqueous phase comprising polyamines and the volume of an organic phase comprising polyacyl chloride are not particularly limited, as long as the amount of the polyamines in the aqueous phase or the amount of the polyacyl chloride in the organic phase can be ensured to form a suitable polyamide layer having a cross-linked structure on the membrane. Preferably, the total amount of polyamines in the aqueous phase may be 0.05-2 g and the total amount of polyacyl chloride in the organic phase may be 0.0001-0.5 g, relative to a membrane area of 400 cm².

According to the present invention, the polyamines are at least one selected from the group consisting of polyethyleneimine, triethylene tetramine, tetraethylene pentamine, diethylene triamine, piperazine, m-phenylenediamine, and p-phenylenediamine, preferably at least one of polyethyleneimine, piperazine, and polyethylene polyamine.

According to the present invention, the polyacyl chloride is at least one selected from the group consisting of trimesoyl chloride, terephthaloyl chloride, isophthaloyl chloride, and phthaloyl chloride, preferably at least one of trimesoyl chloride and terephthaloyl chloride.

According to the present invention, temperature of the thermal treatment is within the range of 40-150° C.; time of the thermal treatment is within the range of 0.5-10 min.

It is understood in the present invention that the polyamines and the polyacyl chloride may carry out the reaction upon contacting, when the above-mentioned thermal treatment conditions are satisfied, it can ensure that the reaction is performed more sufficiently, a more compact polyamide layer is obtained, and after the modification layer is prepared on the surface thereof, the separation membrane having the specific pore size according to the first aspect of the present invention can be prepared.

Further, temperature of the thermal treatment is within the range of 50-120° C.; time of the thermal treatment is within the range of 1-5 min.

In the present invention, the method further comprising: soaking the prepared separation membrane in deionized water to wait for use.

In the third aspect, the present invention discloses a separation membrane prepared with the aforementioned method.

In the fourth aspect, the present invention discloses a use of the separation membrane according to the first aspect or the third aspect in the magnesium-lithium separation (in particular, extraction of lithium from the salt lake).

In the present invention, the specific method for using the separation membrane in the magnesium-lithium separation comprising: loading the salt lake brine into a feed tank, and mounting the separation membrane on a membrane pool; operating the system under pressure I, and collecting the first-stage produced water after filtration with the separation membrane; and filling the first-stage produced water serving as a feedstock liquid into the feed tank, operating the system under pressure II, and collecting the second-stage produced water filtered by the separation membrane.

In the present invention, content of magnesium ions in the salt lake brine is more than or equal to 500 ppm, and content of lithium ions in the salt lake brine is less than or equal to 50 ppm.

In the present invention, a mass concentration ratio of Mg²⁺ to Li⁺ in the salt lake brine is larger than or equal to 5.

In the present invention, the pressure I is within the range of 0.5-2 MPa.

In the present invention, the pressure II is within the range of 0.5-2 MPa.

In the present invention, content of magnesium ions in the first-stage produced water is less than or equal to 20 ppm, and content of lithium ions is greater than or equal to 20 ppm.

In the present invention, mass concentration ratio of Mg²⁺ to Li⁺ in the first-stage produced water is less than or equal to 1.

In the present invention, content of magnesium ions in the second-stage produced water is less than or equal to 0.5 ppm, and content of lithium ions is greater than or equal to 25 ppm.

In the present invention, purity of Li in the second-stage produced water is more than or equal to 98%.

According to the preferred embodiment of the present invention, when the separation membrane is used for magnesium-lithium separation, the separation membrane has a water flux more than or equal to 20 L·m⁻²·h⁻¹; the desalinization rate of MgCl₂ is more than or equal to 99%; and the magnesium-lithium separation coefficient is larger than or equal to 70.

Further, the separation membrane has a water flux within the range of 20-40 L·m⁻²·h⁻¹, the desalinization rate of MgCl₂ is more than or equal to 99%; the magnesium-lithium separation coefficient is within the range of 100-250.

According to a particularly preferred embodiment of the present invention, the separation membrane is prepared according to the following method:
coating the polysulfone solution having a polysulfone concentration of 16-19 wt % on the polyester nonwoven fabric (base material layer) having a thickness of 75-80 μm by using a scraper, then soaking the material in water with a temperature of 24-26° C. for 45-60 min, such that the polysulfone layer on the surface of polyester nonwoven fabric undergoes a phase conversion into a porous membrane, finally washing the porous membrane with water for 2-3 times to obtain a material comprising a base material layer and a porous support layer (the thickness of porous support layer is about 38-42 μm).

Contacting a surface of the porous support layer of a material comprising a base material layer and a porous support layer with an aqueous solution containing 0.5-0.6 wt % polyethyleneimine, after contacting at 24-26° C. for 50-60 s, discharging the liquid; subsequently contacting the upper surface of the supporting layer with Isopar E solution comprising trimesoyl chloride and terephthaloyl chloride (the mass ratio of polyamines in an aqueous phase comprising polyamines to the polyacyl chloride in an organic phase comprising polyacyl chloride is within the range of (5-6): 1, and the mass ratio of trimesoyl chloride to terephthaloyl chloride is within the range of 1: (3-5)), after contacting at 24-26° C. for 60-70 s, discharging the liquid; then placing the membrane in an oven, and heating at 60-70° C. for 3-4 min to obtain a material comprising a base material layer, a porous support layer, and a polyamide layer.

Loading the material comprising a base material layer, a porous support layer, and a polyamide layer into a cross-flow membrane pool, enabling one side of the polyamide layer of the material to contact with a solution in the cross-flow membrane pool, wherein the solution in the cross-flow membrane pool is an aqueous polyphenol solution having a concentration of 0.001-0.005 wt %, operating the cross-flow membrane pool under the pressure of 0.6-0.65 MPa and the temperature of 25-26° C. for 30-35 min under the conditions that the flow rate of the polyphenol solution is kept at 2.5-3.5 L/min, discharging the liquid, and repeatedly flushing the cross-flow membrane pool with deionized water to remove the polyphenols in the system; adding an aqueous polyamine solution (the polyphenol solution and the polyamine solution are used in an amount such that a mass ratio of the polyphenols to the polyamines is within the range of (0.1-10): 1) into the cross-flow membrane pool, contacting one side of a polyamide layer of the material with the solution, operating the cross-flow membrane pool under the pressure of 0.6-0.65 MPa and the temperature of 25-26° C. for 30-35 min under the conditions that the flow rate of the polyamine solution is kept within the range of 0.5-5 L/min, discharging the liquid; repeatedly flushing the cross-flow membrane pool with deionized water to remove the residual polyamines in the system; as a result, one self-assembly reaction is completed, and the operations are repeated to complete the self-assembly reaction again to obtain the separation membrane.

In the present invention, the pressures are gauge pressures.

The present invention will be described in detail below with reference to examples, among them, Isopar E was a commercially available alkane solvent oil (purchased from Xilong Chemical Industry Corporation in China).

In the following examples, when the material comprising a base material layer, a porous support layer, and a polyamide layer was contacted with a solution in the cross-flow membrane pool, water is circulated into the cross-flow membrane pool by a water pump, so that the polyphenol solution and the polyamine solution in the membrane pool were flowing.

In the Examples and Comparative Examples other than Examples 11-12, the materials including a base material layer and a porous support layer were prepared with a method as follows:
the polysulfone (with a number average molecular weight of 80,000 g/mol) was dissolved in N,N-dimethylformamide to prepare a polysulfone solution with a concentration of 18 wt %, the solution was then defoamed at 25° C. for 120 min. The polysulfone solution was then coated on the polyester nonwoven fabric (base material layer) having a thickness of 75 μm by using a scraper, the material was soaked in water at a temperature of 25° C. for 60 min, such that the polysulfone layer on the surface of polyester nonwoven fabric underwent a phase conversion into a porous membrane, finally the porous membrane was washed with water for 3 times to obtain a material comprising a base material layer and a porous support layer (the thickness of porous support layer was about 40 μm) having a total thickness of 115 μm, an area of the material was 400 cm².

The membranes prepared in the following Examples and Comparative Examples were immersed in deionized water for 24 hours waited for use, and then subjected to measurements of various properties and parameters.

The molecular structure of the separation membrane was characterized and analyzed through the total reflection infrared spectrometric analyzer (Nicolet 6700).

The pore size of the separation membrane: was measured with the PEG solute transfer method, the method was composed of the detailed steps as follows:
(1) the retention rate of the separation membrane regarding the PEG having different molecular sizes was tested;
(2) the PEG size and the retention rate were linearly fitted in a log-probability coordinate system, and the PEG size corresponding to the 50% retention rate was the average pore size of the separation membrane.

The surface Zeta potential of separation membrane: was measured through a potentiometric analyzer; the test solution was an aqueous sodium chloride (KCL) solution with a concentration of 0.001 mol/L, and the pH was 7.

The content of nitrogen atoms in the modification layer of the separation membrane: was measured by the X-ray photoelectron spectroscopy (XPS), the content was obtained by irradiation with Al-Kα X-rays on an ESCALAB250 type X-ray photoelectron spectrometer.

The contents of structural units provided by polyphenols and structural units provided by polyamines on the membrane surface of the separation membrane: were measured with the following steps:
a membrane comprising a base material layer, a porous support layer and a polyamide layer was subjected to drying in a vacuum oven at 60° C. for 24 hours, the mass of the membrane was then weighted to be Mₙ, in the unit of mg; the membrane was loaded into a membrane pool, wherein a feeding tank contained an aqueous solution of polyphenols with a certain concentration, after circulation for a certain time under a certain condition, the membrane was taken out, washed the surface of the membrane with deionized water, the membrane was dried at 60° C. for 24 hours, the mass of the membrane was weighted as Wₙ, in the unit of mg; the membrane was again put into a membrane pool, wherein a feeding tank contained an aqueous solution of polyamines with a certain concentration, after circulation for a certain time under a certain condition, the membrane was taken out, the surface of the membrane was washed with deionized water, dried at 60° C. for 24 hours, and the mass of the membrane was weighted as Nₙ, in the unit of mg; the content Pₙ of polyphenols and the content Tₙ of polyamines on the surface of the membrane in each modification of the separation membrane were respectively calculated with the following formulas:

$$Pn = \frac{Wn - Mn}{S} ;$$

wherein, when n was greater than 1, Mₙ=Nₙ₋₁; when n=1, Mₙ was the original mass of the polyamide membrane;

$$Tn = \frac{Nn - Wn}{S} ;$$

after the separation membrane was subjected to self-assembly, the total content of polyphenols on the surface was denoted as ΣPₙ, wherein n was more than or equal to 1; the total content of polyamines on the surface was denoted as ΣTₙ, wherein n was more than or equal to 1;
wherein n denoted the number of self-assembly reactions, S denoted the effective membrane area, in the unit of cm².

Wherein the conditions under which the membrane was contacted with the aqueous solution of polyphenols and the aqueous solution of polyamines corresponded to the first pressure, the second pressure, the temperature and time of the first contact, and the temperature and time of the second contact of the self-assembly process in Examples and Comparative Examples, respectively.

Contact angle of the separation membrane: the DSA100 type surface contact angle measuring instrument produced by German KRUSS Company was used for testing the surface contact angle of a composite membrane sample through a sessile drop method, before the testing, the sample was dried in a vacuum oven at 60° C. for 30 min to remove moisture on the surface and inside the sample, a dried membrane was then pasted on a flat glass slide by a double-sided adhesive tape; the volume of each water drop was 2 μL during testing; the water drop was immediately tested after being dropped on the surface of the membrane for 3 s; and the size of the final contact angle was determined by measuring for many times and averaging the measurement results.

The separation membrane and thicknesses of each layer in the separation membrane: the thickness of the separation membrane, the porous support layer, and the polyamide layer were measured by a micrometer caliper and a scanning electron microscope (SEM); and the thickness of the modification layer was obtained by subtracting the thicknesses of the base material layer, the porous support layer and the polyamide layer from the thickness of the separation membrane. Wherein the thickness of the base material layer was exactly the thickness measured before coating the porous support layer material solution.

### Example 1

The surface of a porous support layer of a material comprising a base material layer and a porous support layer was contacted with an aqueous solution (50 mL) of polyethyleneimine having a concentration of 0.5 wt %, after the contact was performed at 25° C. for the 60 s, the solution was discharged; the upper surface of the supporting layer was then contacted with the Isopar E solution (30 mL) comprising 0.02 wt % of trimesoyl chloride and 0.08 wt % of terephthaloyl chloride, after the contact was performed at 25° C. for 60 s, the solution was discharged; the membrane was subsequently placed in an oven and heated at 70° C. for 3 min.

The product obtained after thermal treatment was loaded into a cross-flow membrane pool, such that the polyamide layer side of the material was subjected to a first contact with an aqueous tannic acid solution having a concentration of 0.001 wt % in the cross-flow membrane pool, the volume of the aqueous tannic acid solution was 5 L, the cross-flow membrane pool was operated under the pressure of 0.6 MPa and the temperature of 25° C. for 30 min, under the conditions that the tannic acid solution was kept in a fluid state with a flow rate of 1.5 L/min; the solution was discharged; the cross-flow membrane pool was repeatedly washed with deionized water to rinse the tannic acid in the system; 5 L of an aqueous polyethyleneimine solution having a concentration of 0.004 wt % was added into the cross-flow membrane pool, the aqueous polyethyleneimine solution was kept in a fluid state at a flow speed of 1.5 L/min, so that the polyamide layer side of the material was subjected to a second contact with the solution, the cross-flow membrane pool was operated under the pressure of 0.6 MPa and the temperature of 25° C. for 30 min; the solution was discharged; the cross-flow membrane pool was repeatedly washed with deionized water to rinse the residual polyethyleneimine; therefore, one self-assembly reaction was completed, the operations were repeated to complete the self-assembly reaction again, and in one self-assembly process, the mass ratio of the polyphenols to the polyamines was 0.25:1, the separation membrane N1 was prepared.

### Example 2

The surface of a porous support layer of a material comprising a base material layer and a porous support layer was contacted with an aqueous solution (50 mL) of polyethylene polyamine having a concentration of 1 wt %, after the contact was performed at 25° C. for the 20 s, the solution was discharged; the upper surface of the supporting layer was then contacted with the Isopar E solution (30 mL) comprising 0.18 wt % of trimesoyl chloride and 0.12 wt % of terephthaloyl chloride, after the contact was performed at 25° C. for 30 s, the solution was discharged; the membrane was subsequently placed in an oven and heated at 50° C. for 3 min.

The product obtained after thermal treatment was loaded into a cross-flow membrane pool, such that the polyamide layer side of the material was subjected to a first contact with an aqueous tannic acid solution having a concentration of 0.01 wt % in the cross-flow membrane pool, the volume of the aqueous tannic acid solution was 5 L, the cross-flow membrane pool was operated under the pressure of 0.6 MPa and the temperature of 15° C. for 40 min, under the conditions that the tannic acid solution was kept in a fluid state with a flow rate of 0.5 L/min; the solution was discharged; the cross-flow membrane pool was repeatedly washed with deionized water to rinse the residual tannic acid; 5 L of an aqueous polyethyleneimine solution having a concentration of 0.045 wt % was added into the cross-flow membrane pool, the aqueous polyethyleneimine solution was kept in a fluid state at a flow speed of 0.5 L/min, so that the polyamide layer side of the material was subjected to a second contact with the solution, the cross-flow membrane pool was operated under the pressure of 0.6 MPa and the temperature of 15° C. for 40 min; the solution was discharged; the cross-flow membrane pool was repeatedly washed with deionized water to rinse the residual polyethyleneimine; therefore, one self-assembly reaction was completed, the operations were repeated to complete the self-assembly reaction again, and in one self-assembly process, the mass ratio of the polyphenols to the polyamines was 0.22:1, the separation membrane N2 was prepared.

### Example 3

The surface of a porous support layer of a material comprising a base material layer and a porous support layer was contacted with an aqueous solution (50 mL) of piperazine having a concentration of 2.5 wt %, after the contact was performed at 25° C. for the 40 s, the solution was discharged; the upper surface of the supporting layer was then contacted with the Isopar E solution (30 mL) comprising 0.2 wt % of trimesoyl chloride and 0.1 wt % of terephthaloyl chloride, after the contact was performed at 25° C. for 100 s, the solution was discharged; the membrane was subsequently placed in an oven and heated at 110° C. for 1 min.

The product obtained after thermal treatment was loaded into a cross-flow membrane pool, such that the polyamide layer side of the material was subjected to a first contact with an aqueous tannic acid solution having a concentration of 0.1 wt % in the cross-flow membrane pool, the volume of the aqueous tannic acid solution was 5 L, the cross-flow membrane pool was operated under the pressure of 0.6 MPa and the temperature of 30° C. for 20 min, under the conditions that the tannic acid solution was kept in a fluid state with a flow rate of 5 L/min; the solution was discharged; the cross-flow membrane pool was repeatedly washed with deionized water to rinse the residual tannic acid; 5 L of an aqueous polyethyleneimine solution having a concentration of 0.1 wt % was added into the cross-flow membrane pool, the aqueous polyethyleneimine solution was kept in a fluid state at a flow speed of 5 L/min, so that the polyamide layer side of the material was subjected to a second contact with the solution, the cross-flow membrane pool was operated under the pressure of 0.6 MPa and the temperature of 30° C. for 20 min; the solution was discharged; the cross-flow membrane pool was repeatedly washed with deionized water to rinse the residual polyethyleneimine; therefore, one self-assembly reaction was completed, the operations were repeated to complete the self-assembly reaction again, and in one self-assembly process, the mass ratio of the polyphenols to the polyamines was 1:1, the separation membrane N3 was prepared.

### Example 4

The separation membrane was prepared according to the method of Example 1, except that in the self-assembly reaction, polyethyleneimine was replaced with polyethylene polyamine. The separation membrane N4 was prepared.

### Example 5

The separation membrane was prepared according to the method of Example 1, except that in the self-assembly reaction, polyethyleneimine was replaced with tetraethylene pentamine. The separation membrane N5 was prepared.

### Example 6

The separation membrane was prepared according to the method of Example 1, except that in the self-assembly reaction, polyethyleneimine was replaced with triethylene tetramine. The separation membrane N6 was prepared.

### Example 7

The separation membrane was prepared according to the method of Example 1, except that the self-assembly reaction was performed only once. The separation membrane N7 was prepared.

### Example 8

The separation membrane was prepared according to the method of Example 1, except that the self-assembly reaction was performed three times. The separation membrane N8 was prepared.

### Example 9

The separation membrane was prepared according to the method of Example 1, except that the self-assembly reaction was performed in total of four times. The separation membrane N9 was prepared.

### Example 10

The separation membrane was prepared according to the method of Example 1, except that the self-assembly reaction was performed in total of five times. The separation membrane N10 was prepared.

### Example 11

The separation membrane was prepared according to the method of Example 1, except that the materials including a base material layer and a porous support layer were prepared as follows: the polysulfone (with a number average molecular weight of 70,000 g/mol) was dissolved in N,N-dimethylformamide to prepare a polysulfone solution with a concentration of 20 wt %, the solution was then defoamed at 25° C. for 120 min. The polysulfone solution was then coated on the polyester nonwoven fabric (base material layer) having a thickness of 100 μm by using a scraper, the material was soaked in water at temperature of 23° C. for 20 min, such that the polysulfone layer on the surface of polyester nonwoven fabric underwent a phase conversion into a porous membrane, finally the porous membrane was washed with water for 3 times to obtain a material comprising a base material layer and a porous support layer (the thickness of porous support layer was 35 μm) having a total thickness of 135 μm, an area of the material was 400 cm². The separation membrane N11 was prepared.

### Example 12

The separation membrane was prepared according to the method of Example 1, except that the materials including a base material layer and a porous support layer were prepared as follows: the polyacrylonitrile (with a number average molecular weight of 100,000 g/mol) was dissolved in N,N-dimethylformamide to prepare a polyacrylonitrile solution with a concentration of 15 wt %, the solution was then defoamed at 25° C. for 120 min. The polyacrylonitrile solution was then coated on the polypropylene nonwoven fabric (base material layer) having a thickness of 115 μm by using a scraper, the material was soaked in water at the temperature of 28° C. for 40 min, such that the polyacrylonitrile layer on the surface of polypropylene nonwoven fabric underwent a phase conversion into a porous membrane, finally the porous membrane was washed with water for 3 times to obtain a material comprising a base material layer and a porous support layer (the thickness of porous support layer was 45 μm) having a total thickness of 160 μm, an area of the material was 400 cm². The separation membrane N12 was prepared.

### Example 13

The separation membrane was prepared according to the method of Example 1, except that in the self-assembly reaction, the concentration of tannic acid in the aqueous tannic acid solution was 0.0001 wt %, the concentration of polyethyleneimine in the polyethyleneimine solution was 0.001 wt %, and the mass ratio of polyphenols to polyamines in the one self-assembly process was 0.1:1. The separation membrane N13 was prepared.

### Example 14

The separation membrane was prepared according to the method of Example 1, except that the first pressure and the second pressure in the self-assembly process were each 0.2 MPa, and the flow rates of solutions were each 1.5 L/min, the separation membrane N14 was prepared.

### Example 15

The separation membrane was prepared according to the method of Example 1, except that the pressures of the first contact and the second contact in the self-assembly process were each 1 MPa, and the flow rates of solutions were each 1.5 L/min, the separation membrane N15 was prepared.

### Example 16

The separation membrane was prepared according to the method of Example 1, except that the pressures of the first contact and the second contact in the self-assembly process were each 0.8 MPa, and the flow rates of solutions were each 1.5 L/min, the separation membrane N16 was prepared.

### Example 17

The separation membrane was prepared according to the method of Example 1, except that the pressures of the first contact and the second contact in the self-assembly process were each 0.4 MPa, and the flow rates of solutions were each 1.5 L/min, the separation membrane N17 was prepared.

### Example 18

The surface of a porous support layer of a material comprising a base material layer and a porous support layer was contacted with an aqueous solution (50 mL) of polyethyleneimine having a concentration of 0.5 wt %, after the contact was performed at 25° C. for the 60 s, the solution was discharged; the upper surface of the supporting layer was then contacted with the Isopar E solution (30 mL) comprising 0.01 wt % of trimesoyl chloride and 0.04 wt % of terephthaloyl chloride, after the contact was performed at 25° C. for 60 s, the solution was discharged; the membrane was subsequently placed in an oven and heated at 70° C. for 3 min.

The product obtained after thermal treatment was loaded into a cross-flow membrane pool, such that the polyamide layer side of the material was subjected to a first contact with an aqueous tannic acid solution having a concentration of 0.001 wt % in the cross-flow membrane pool, the volume of the aqueous tannic acid solution was 5 L, the cross-flow membrane pool was operated under the pressure of 0.6 MPa and the temperature of 25° C. for 30 min, under the conditions that the tannic acid solution was kept in a fluid state with a flow rate of 1.5 L/min; the solution was discharged; the cross-flow membrane pool was repeatedly washed with deionized water to rinse the tannic acid in the system; 5 L of an aqueous polyethyleneimine solution having a concentration of 0.004 wt % was added into the cross-flow membrane pool, the aqueous polyethyleneimine solution was kept in a fluid state at a flow speed of 1.5 L/min so that the polyamide layer side of the material was subjected to a second contact with the solution, the cross-flow membrane pool was operated under the pressure of 0.6 MPa and the temperature of 25° C. for 30 min; the solution was discharged; the cross-flow membrane pool was repeatedly washed with deionized water to rinse the residual polyethyleneimine; therefore, one self-assembly reaction was completed, the operations were repeated to complete the self-assembly reaction again, and in the one self-assembly process, the mass ratio of the polyphenols to the polyamines was 0.25:1, the separation membrane N18 was prepared.

### Example 19

The separation membrane was prepared according to the method of Example 1, except that in the self-assembly reaction, the concentration of tannic acid in the aqueous tannic acid solution was 0.001 wt %, the concentration of polyethyleneimine in the polyethyleneimine solution was 0.0001 wt %, and the mass ratio of polyphenols to polyamines in the one self-assembly process was 10:1. The separation membrane N19 was prepared.

### Comparative Example 1

The separation membrane was prepared according to the method of Example 1, except that the self-assembly reaction was not carried out, that is, the separation membrane was directly obtained after the thermal treatment. The separation membrane D1 was prepared.

### Comparative Example 2

The separation membrane was prepared according to the method of Example 1, except that the heat-treated product was loaded into a cross-flow membrane pool containing 0.001 wt % of an aqueous tannic acid solution having a volume of 5 L and kept in a fluid state at a flow rate of 1.5 L/min, after operated at 25° C. under 0.6 MPa for 30 min, the product was taken out to obtain the separation membrane (i.e., it was contacted with the aqueous tannic acid solution only once). The separation membrane D2 was prepared.

### Comparative Example 3

The separation membrane was prepared according to the method of Example 1, except that polyethyleneimine was replaced with polyvinyl alcohol. The separation membrane D3 was prepared.

### Comparative Example 4

A polyacrylonitrile ultrafiltration membrane was put into a cross-flow membrane pool, wherein one side of the polyacrylonitrile ultrafiltration membrane was in contact with a solution in the cross-flow membrane pool, the solution in the cross-flow membrane pool was 5 L of aqueous tannic acid solution having a concentration of 0.001 wt %, the aqueous tannic acid solution was kept in a fluid state at a flow rate of 1.5 L/min; after the cross-flow membrane pool was operated under the pressure of 0.6 MPa and the temperature of 25° C. for 30 min, the solution was discharged; the cross-flow membrane pool was repeatedly washed with deionized water to rinse the tannic acid in the system; 5 L of an aqueous polyethyleneimine solution having a concentration of 0.004 wt % was added into the cross-flow membrane pool, so that the polyacrylonitrile layer side of the material was in contact with the solution, the flow rate was 1.5 L/min, after the cross-flow membrane pool was operated under the pressure of 0.6 MPa and the temperature of 25° C. for 30 min, the solution was discharged; the cross-flow membrane pool was repeatedly washed with deionized water to rinse the residual polyethyleneimine; therefore, one self-assembly reaction was completed, the operations were repeated to complete one self-assembly reaction again, and in the one self-assembly process, the mass ratio of the polyphenols to the polyamines was 0.25:1, the separation membrane D4 was prepared.

### Comparative Example 5

The separation membrane was prepared according to the method of Example 1, except that a porous support layer comprising a base material layer and a porous support material was loaded into a cross-flow membrane pool, such that one side of a porous support layer was subjected to a first contact with an aqueous tannic acid solution having a concentration of 0.001 wt % in the cross-flow membrane pool, the volume of the aqueous tannic acid solution was 5 L, the cross-flow membrane pool was operated under the pressure of 0.6 MPa and the temperature of 25° C. for 30 min, under the conditions that the tannic acid solution was kept in a fluid state with a flow rate of 1.5 L/min; the solution was discharged; the cross-flow membrane pool was repeatedly washed with deionized water to rinse the tannic acid in the system; 5 L of an aqueous polyethyleneimine solution having a concentration of 0.004 wt % was added into the cross-flow membrane pool, the aqueous polyethyleneimine solution was kept in a fluid state at a flow speed of 1.5 L/min, so that one side of the material was subjected to a second contact with the solution, the cross-flow membrane pool was operated under the pressure of 0.6 MPa and the temperature of 25° C. for 30 min; the solution was discharged; the membrane was taken out and its surface was repeatedly washed with deionized water to obtain the porous support layer modified with polyphenols and polyamines; in the one self-assembly process, the mass ratio of the polyphenols to the polyamines was 0.25:1;

The surface of the porous support layer modified with polyphenols and polyamines was contacted with an aqueous polyethyleneimine solution (50 mL) having a concentration of 0.5 wt %, after the contact was performed at 25° C. for the 60 s, the solution was discharged; the upper surface of the supporting layer was contacted with the Isopar E solution (30 mL) comprising 0.02 wt % of trimesoyl chloride and 0.08 wt % of terephthaloyl chloride, after the contact was performed at 25° C. for 60 s, the solution was discharged; the membrane was subsequently placed in an oven and heated at 70° C. for 3 min. The polyamide composite membrane D5 comprising polyphenols and a polyphenol intermediate layer was prepared.

### Comparative Example 6

The separation membrane was prepared according to the method of Example 1, except that the product obtained after thermal treatment was not loaded into a cross-flow membrane pool for self-assembly reaction, but the polyamide layer side of the material was directly contacted with an aqueous tannic acid solution (i.e., the first pressure was 0 MPa, and the tannic acid solution did not flow) in a beaker containing the aqueous tannic acid solution, the material was taken out after 24 h, and repeatedly rinsed with deionized water; the polyamide layer side of the material was then directly contacted with an aqueous polyethyleneimine solution (i.e., the second pressure was 0 MPa, and the polyethyleneimine solution did not flow) in a beaker filled with the aqueous polyethyleneimine solution, the material was taken out after 24 hours, and repeatedly washed with deionized water; the above operations were repeated to complete one self-assembly reaction again to obtain the separation membrane. Wherein, in each self-assembly reaction, the volume of the tannic acid solution (or polyamine) in the beaker was arranged such that the total amount of the tannic acid (or polyamine) exceeds the amount that can be attached to the membrane and carried out the reaction. The separation membrane D6 was prepared.

### Comparative Example 7

A surface of the porous support layer of a material comprising a base material layer and a porous support layer was contacted with an aqueous solution (50 mL) containing polyethyleneimine in a concentration of 0.5 wt %, after the contact was performed at 25° C. for the 60 s, the solution was discharged; the upper surface of the supporting layer was then contacted with the Isopar E solution (30 mL) comprising 0.02 wt % of trimesoyl chloride and 0.08 wt % of terephthaloyl chloride, after the contact was performed at 25° C. for 60 s, the solution was discharged; the membrane was subsequently placed in an oven and heated at 70° C. for 3 min.

The obtained membrane was immersed into 1 L of 2 wt % aqueous tannic acid solution (the first pressure was 0 MPa, and the tannic acid solution did not flow) for 1 min, the membrane was taken out, and the surface of said membrane was washed with deionized water; the membrane was then immersed in 1 L of 2 wt % aqueous polyethyleneimine solution (the second pressure was 0 MPa, and the polyethyleneimine solution did not flow) for 1 min, and in the one self-assembly process, the mass ratio of the polyphenols to the polyamines was 1:1, after the membrane was taken out, the membrane surface was rinsed with deionized water, and the separation membrane D7 was prepared.

### Comparative Example 8

The separation membrane was prepared according to the method of example 1 except that the first pressure and the second pressure in the self-assembly process were both 0 MPa and the solution flow rate was both 1.5 L/min, to obtain separation membrane D8.

### Comparative Example 9

The separation membrane was prepared according to the method of Example 1, except that the polyamide membrane was initially contacted with the polyethyleneimine solution, and then contacted with the tannic acid solution, and the self-assembly process was performed only once, the separation membrane D9 was prepared.

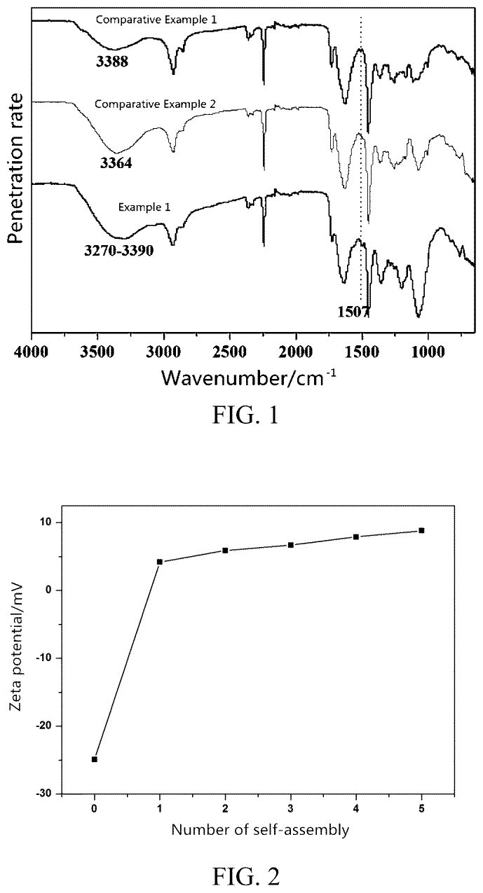

Infrared spectrum characterization was performed on the separation membranes prepared in Example 1 and Comparative Examples 1-2, and the results were shown in FIG. 1.

As can be seen, the membrane without self-assembly modification of the tannic acid and polyethyleneimine (the membrane prepared in Comparative Example 1) has a broad peak at 3388 cm⁻¹ corresponding to an unreacted amino group on the polyamide surface, and the membrane shows a weak signal at 1507 cm⁻¹ corresponding to N—H stretching vibration. After the modification with the tannic acid (i.e., the membrane prepared in Comparative Example 2), a strong absorption peak exists at 3364 cm⁻¹, which corresponds to the phenolic hydroxyl groups in the tannic acid molecules, and the signal peak at 1507 cm⁻¹ basically disappears, thus confirming that the amino groups and the tannic acid have carried out a chemical reaction. After two times consecutive self-assembly processes of the tannic acid and polyethyleneimine on the surface of polyamide (membrane prepared in Example 1), a broad peak appears at 3270-3390 cm⁻¹, corresponding to unreacted amino groups and unreacted phenylic hydroxyl groups on the modification layer; and the signal intensity at 1507 cm⁻¹ is enhanced, confirming that the polyethyleneimine is modified to the membrane surface. In combination with the operations and infrared images of Comparative Example 2, it can be seen for the separation membrane prepared in Example 1, the cross-linked polymers forming the modification layer include structural units provided by tannic acid and structural units provided by polyamines, the structural units provided by tannic acid are also linked with the polyamide layer through the ortho-positions of phenolic hydroxyl groups.

The results of infrared characterization of the separation membranes prepared in Examples 2-19 are similar to those of the separation membrane prepared in Example 1 (not shown).

TABLE 1

| | The pore | The thickness | The thickness | | |
|---|---|---|---|---|---|
| | size of the | of the | of the | | |
| | separation | base | porous | The thickness | The thickness |
| | membrane | material | support | of polyamide | of modification |
| | (nm) | layer (μm) | layer (μm) | layer (nm) | layer (nm) |
| Example 1 | 0.20 | 75 | 40 | 85 | 13 |
| Example 2 | 0.19 | 75 | 40 | 105 | 22 |
| Example 3 | 0.26 | 75 | 40 | 128 | 45 |
| Example 4 | 0.22 | 75 | 40 | 85 | 19 |
| Example 5 | 0.24 | 75 | 40 | 85 | 17 |
| Example 6 | 0.24 | 75 | 40 | 85 | 14 |
| Example 7 | 0.27 | 75 | 40 | 85 | 10 |
| Example 8 | 0.18 | 75 | 40 | 85 | 18 |
| Example 9 | 0.16 | 75 | 40 | 85 | 23 |
| Example 10 | 0.15 | 75 | 40 | 85 | 31 |
| Example 11 | 0.21 | 100 | 35 | 81 | 14 |
| Example 12 | 0.23 | 115 | 45 | 78 | 12 |
| Example 13 | 0.28 | 75 | 40 | 85 | 10 |
| Example 14 | 0.25 | 75 | 40 | 85 | 11 |
| Example 15 | 0.17 | 75 | 40 | 85 | 18 |
| Example 16 | 0.18 | 75 | 40 | 85 | 15 |
| Example 17 | 0.19 | 75 | 40 | 85 | 12 |
| Example 18 | 0.30 | 75 | 40 | 56 | 16 |
| Example 19 | 0.21 | 75 | 40 | 85 | 13 |
| Comparative | 0.35 | 75 | 40 | 85 | / |
| Example 1 | | | | | |
| Comparative | 0.23 | 75 | 40 | 85 | 7 |
| Example 2 | | | | | |
| Comparative | 0.18 | 75 | 40 | 85 | 15 |
| Example 3 | | | | | |
| Comparative | 0.71 | 75 | 32* | / | 29 |
| Example 4 | | | | | |
| Comparative | 0.37 | 75 | 40 | 70 | 6 |
| Example 5 | | | | | |
| Comparative | 0.31 | 75 | 40 | 85 | 7 |
| Example 6 | | | | | |
| Comparative | 0.33 | 75 | 40 | 85 | 20 |
| Example 7 | | | | | |
| Comparative | 0.29 | 75 | 40 | 85 | 8 |
| Example 8 | | | | | |
| Comparative | 0.25 | 75 | 40 | 85 | 9 |
| Example 9 | | | | | |

*Comparative Example 4 denotes the thickness of the polyacrylonitrile ultrafiltration membrane.

TABLE 2

| | | The content | The content | The content | |
|---|---|---|---|---|---|
| | Surface | of structural | of structural | of nitrogen | |
| | Zeta | units provided | units provided | atoms on the | Contact |
| | potential | by polyphenols | by polyamines | membrane | angle |
| | (mV) | (mg/cm²) | (mg/cm²) | surface (%) | (°) |
| Example 1 | 5.9 | 9.4 × 10⁻³ | 7.2 × 10⁻³ | 15.79 | 31.8 |
| Example 2 | 6.4 | 1.2 × 10⁻² | 9.8 × 10⁻³ | 16.02 | 30.7 |
| Example 3 | 7.3 | 2.7 × 10⁻² | 1.2 × 10⁻² | 16.35 | 29.5 |
| Example 4 | 5.1 | 9.4 × 10⁻³ | 5.6 × 10⁻³ | 15.16 | 34.9 |
| Example 5 | 4.5 | 9.4 × 10⁻³ | 5 × 10⁻³ | 14.85 | 36.1 |
| Example 6 | 4 | 9.4 × 10⁻³ | 4.2 × 10⁻³ | 14.18 | 37 |
| Example 7 | 4.2 | 6.1 × 10⁻³ | 4.6 × 10⁻³ | 14.47 | 46.5 |
| Example 8 | 6.7 | 2.2 × 10⁻² | 1 × 10⁻² | 16.29 | 28.7 |
| Example 9 | 7.9 | 3.0 × 10⁻² | 1.5 × 10⁻² | 16.40 | 24.3 |
| Example 10 | 8.8 | 3.6 × 10⁻² | 1.9 × 10⁻² | 16.59 | 19.2 |
| Example 11 | 5.9 | 8.9 × 10⁻³ | 7 × 10⁻³ | 15.60 | 31 |
| Example 12 | 6.0 | 9.1 × 10⁻³ | 7.8 × 10⁻³ | 15.84 | 30.3 |
| Example 13 | 1.5 | 2.9 × 10⁻³ | 1.6 × 10⁻³ | 13.74 | 36.9 |
| Example 14 | 3.9 | 5.8 × 10⁻³ | 3.9 × 10⁻³ | 14.02 | 48.3 |
| Example 15 | 6.8 | 1.0 × 10⁻² | 8.3 × 10⁻³ | 15.87 | 31.5 |
| Example 16 | 6.5 | 9.8 × 10⁻³ | 7.5 × 10⁻³ | 15.85 | 32.0 |
| Example 17 | 4.3 | 8.0 × 10⁻³ | 6.7 × 10⁻³ | 15.30 | 46.0 |
| Example 18 | 6.2 | 1.7 × 10⁻² | 0.9 × 10⁻² | 15.95 | 36.9 |
| Example 19 | 1.1 | 6.5 × 10⁻³ | 1.1 × 10⁻³ | 13.52 | 38 |
| Comparative | −24.9 | / | / | 12.25 | 51.3 |
| Example 1 | | | | | |
| Comparative | −18.7 | 9.4 × 10⁻³ | / | 11.48 | 59.2 |
| Example 2 | | | | | |
| Comparative | −8.7 | 9.4 × 10⁻³ | / | 10.29 | 39.5 |
| Example 3 | | | | | |
| Comparative | 9.6 | 8.3 × 10⁻² | 7 × 10⁻² | 20.26 | 38.1 |
| Example 4 | | | | | |
| Comparative | −20.3 | 6 × 10⁻² | 3.1 × 10⁻² | 12.74 | 50.6 |
| Example 5 | | | | | |
| Comparative | −11.5 | 1.8 × 10⁻³ | 0.7 × 10⁻³ | 13.04 | 48.7 |
| Example 6 | | | | | |
| Comparative | −21.7 | 1.3 × 10⁻³ | 0.52 × 10⁻³ | 12.46 | 49.9 |
| Example 7 | | | | | |
| Comparative | −5.2 | 3.6 × 10⁻³ | 0.83 × 10⁻³ | 13.27 | 59 |
| Example 8 | | | | | |
| Comparative | −17 | 1.0 × 10⁻² | / | 11.39 | 60.2 |
| Example 9 | | | | | |

As can be seen from Table 1 and Table 2, as compared with the separation membranes prepared in Comparative Examples 1-9, the separation membranes provided by the Examples 1-19 have a small pore size, and the modification layers of the separation membranes have a high positive charge density.

Wherein the thickness of the modification layer in Comparative Example 2 exhibits the thickness variation generated by the tannic acid; the thickness of the modification layer in Comparative Example 3 illustrates the thickness variation generated by the reaction of the tannic acid with polyvinyl alcohol.

Further, the separation membrane provided by the present invention has a small pore size and high surface Zeta potential; when the separation membrane is used for magnesium-lithium separation, it can significantly improve the interception rate of magnesium chloride; in addition, the separation membrane has excellent hydrophilicity, and can exhibit the excellent water permeability.

As can be seen from FIG. 2, when the number of self-assembly processes increases, the membrane surface potential exhibits positive electricity, and its absolute value shows an incremental tendency. It demonstrates that the content of amine groups (primary amine, secondary amine, or tertiary amine) on the membrane surface is increased along with the increased number of the self-assembly processes, so that the surface Zeta potential of the membrane is improved.

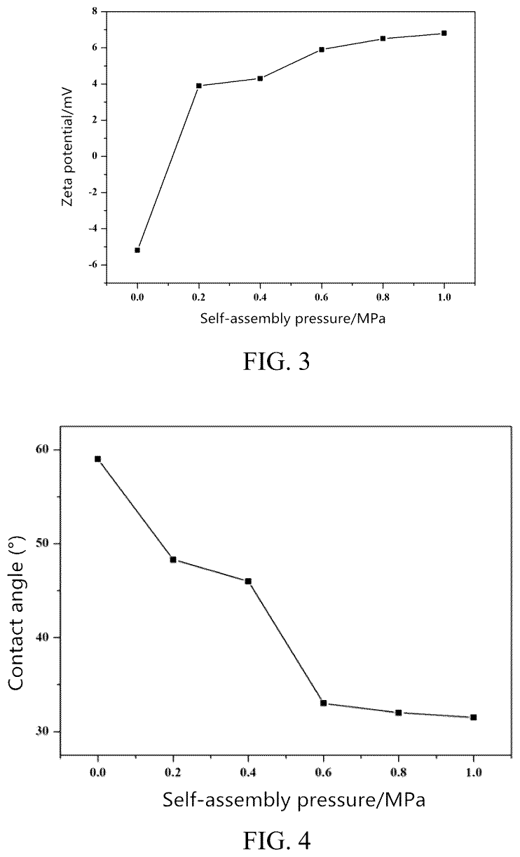

As can be seen from FIG. 3, when the self-assembly pressure (i.e., the first pressure/the second pressure) increases during the self-assembly process, the absolute value of the positive potential at the membrane surface increases, indicating that the pressure can promote the reaction of higher contents of polyphenols and polyamines on the membrane surface.

As can be seen from FIG. 4, when the self-assembly pressure (i.e., the first pressure/the second pressure) increases during the self-assembly process, the content of the hydrophilic groups (e.g., primary amine, secondary amine, or tertiary amine) on the membrane surface increases, so that the hydrophilicity of the membrane surface increases.

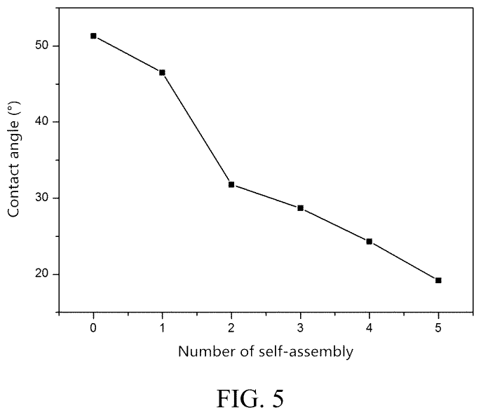

As can be seen from FIG. 5, the content of the hydrophilic groups (e.g., primary amine, secondary amine, or tertiary amine) on the membrane surface increases along with the increased number of self-assembly process, thus the hydrophilicity of the membrane surface is improved.

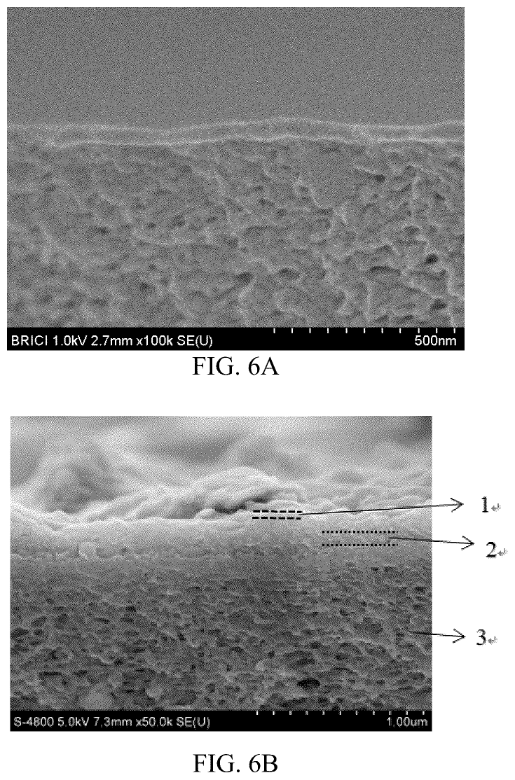

As can be seen from FIG. 6a, the polyamide layer without the modification of polyphenols and polyamines is smooth and thin, and has a thickness of 85 nm; as can be seen from FIG. 6b, after the surface of the polyamide layer is subjected to the self-assembly modification by the polyphenols and polyamines, the surface of the polyamide layer is covered by the modification layer having a thickness of about 30 nm.

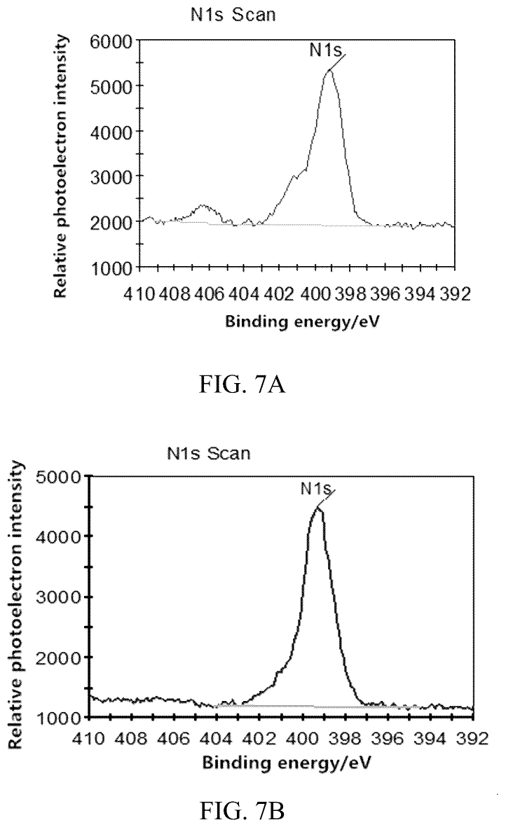

FIG. 7 compares the XPS nitrogen element charts of the separation membranes prepared in Example 1 (FIG. 7a) and Comparative Example 6 (FIG. 7b), as can be seen from the figures, the modification layer of Example 1 has a characteristic peak at 407 eV which corresponds to structural units shown by formula I, i.e., the signal peak generated by the π-π* electron conjugate formed by the benzene ring-nitrogen atom-benzene ring. However, Comparative Example 6 lacks the signal peak, indicating that the structural units shown by formula I are produced only under the process conditions of the pressure-driven self-assembly of the present invention. One nitrogen atom in the structural units carries out a crosslinking reaction with two benzene rings, so that the compactness of the separation membrane is improved, and it further produces the effect of reducing the separation membrane pore size.

### Application Example

The separation membranes prepared in Examples and comparative examples were separately loaded into a cross-flow membrane pool, and the water permeation amount of the separation membranes over a certain time was measured under the pressure of 0.6 MP and the temperature of 25° C., and the water flux was calculated based on the following formula:
J=Q/(A·t), wherein J denoted the water flux (L/m² h), Q denoted the water permeation amount (L), A denoted the effective membrane area (m²) of the separation membrane, and t denoted the time (h). The separation membranes were loaded into a cross-flow membrane pool, wherein the raw material liquid contained magnesium chloride in a concentration of 2,000 ppm or lithium chloride in a concentration of 2,000 ppm, after prepressing for 0.5 h under the pressure of 0.2 MPa, the permeate was obtained under the pressure of 0.6 MPa and the temperature 25° C. of the raw material liquid, the concentrations of the magnesium chloride and the lithium chloride in the permeate were measured through a conductivity meter, and the desalination rate was calculated based on the following formula:
R (%)=(C_{f}−C_{P})/C_{f}×100%, wherein R denoted the desalinization rate, C_{f} denoted the concentration of magnesium chloride or lithium chloride in the raw material liquid (measured by a conductivity meter), and Cₚ denoted the concentration of magnesium chloride or lithium chloride in the permeate (measured by the conductivity meter);
the separation membranes were loaded into a cross-flow membrane pool, wherein the raw material liquid contained magnesium chloride in a concentration of 2,000 ppm and lithium chloride in a concentration of 100 ppm, after prepressing for 0.5 h under the pressure of 0.2 MPa, the permeate was obtained under the pressure of 0.6 MPa and the temperature 25° C. of the raw material liquid, the concentrations of magnesium ions and lithium ions in the permeate were measured through an ion chromatography (IC), and the magnesium-lithium separation coefficient was calculated based on the following formula:

$$S = \frac{{C}_{Li , p} / {C}_{Mg , p}}{{C}_{Li , f} / {C}_{Mg , f}}$$

wherein S denoted a magnesium-lithium separation coefficient, C_{Li}, p and C_{Li, f} denoted the concentrations of lithium ions in the permeate and the raw material liquid respectively (measured by the ion chromatography); C_{Mg, p} and C_{Mg, f} denoted the concentrations of magnesium ions in the permeate and the raw material liquid respectively (measured by the ion chromatography).

TABLE 3

| | | Desalini- | Desalini- | Magnesium- |
|---|---|---|---|---|
| | | zation | zation | lithium |
| | Water flux | rate of | rate of | separation |
| | (L · m⁻² · h⁻¹) | MgCl₂ (%) | LiCl (%) | coefficient |
| Example 1 | 34.7 | 99.81 | 56.15 | 233 |
| Example 2 | 28.6 | 99.70 | 55.60 | 175 |
| Example 3 | 21.2 | 99.78 | 56.04 | 195 |
| Example 4 | 32.5 | 99.68 | 54.36 | 151 |
| Example 5 | 30.8 | 99.55 | 52.87 | 123 |
| Example 6 | 28 | 99.48 | 50.62 | 102 |
| Example 7 | 37.1 | 99.50 | 51.90 | 115 |
| Example 8 | 29 | 99.82 | 60.90 | 214 |
| Example 9 | 23.9 | 99.85 | 64.29 | 201 |
| Example 10 | 20.6 | 99.88 | 67.93 | 189 |
| Example 11 | 33.0 | 99.75 | 56.00 | 190 |
| Example 12 | 31.6 | 99.72 | 55.68 | 181 |
| Example 13 | 38.2 | 99.00 | 43.21 | 72 |
| Example 14 | 36.2 | 99.37 | 46.26 | 89 |
| Example 15 | 27 | 99.83 | 61.02 | 185 |
| Example 16 | 28.1 | 99.82 | 60.59 | 179 |
| Example 17 | 35.0 | 99.42 | 47.05 | 93 |
| Example 18 | 37.8 | 98.92 | 39.64 | 70 |
| Example 19 | 35.5 | 98.85 | 39.20 | 67 |
| Comparative | 42.5 | 97.60 | 24.70 | 35 |
| Example 1 | | | | |
| Comparative | 35.9 | 98.53 | 42.88 | 59 |
| Example 2 | | | | |
| Comparative | 31.8 | 98.75 | 44.57 | 64 |
| Example 3 | | | | |
| Comparative | 47.1 | 53.39 | 15.36 | 2 |
| Example 4 | | | | |
| Comparative | 38 | 97.90 | 39.64 | 46 |
| Example 5 | | | | |
| Comparative | 39.5 | 98.26 | 31.75 | 53 |
| Example 6 | | | | |
| Comparative | 41.3 | 96.64 | 25 | 38 |
| Example 7 | | | | |
| Comparative | 39.7 | 98.15 | 30.28 | 49 |
| Example 8 | | | | |
| Comparative | 35 | 98.64 | 43.07 | 60 |
| Example 9 | | | | |

As illustrated by Table 3, the separation membranes prepared in Examples using the technical scheme of the present invention have both a higher water flux and a higher magnesium-lithium separation efficiency. Along with an increased number of the self-assembly process, the contents of polyphenols and polyamine on the membrane surface are increased, so that the hydrophilicity and surface Zeta potential of the membrane surface are improved. The interception rate of the membrane regarding magnesium chloride is increased, thus the magnesium-lithium separation coefficient is increased. On the other hand, the thickness of the modification layer increases due to the increased number of self-assembly processes, and the water flux of the membrane decreases. In addition, as the operating pressure is increased in the self-assembly process, the reaction is performed more efficiently, so that the surface hydrophilicity and surface Zeta potential of the membrane are increased, thus the membrane has a higher salt interception rate and magnesium-lithium separation efficiency.

The above content describes in detail the preferred embodiments of the invention, but the invention is not limited thereto. A variety of simple modifications can be made in regard to the technical solutions of the invention within the scope of the technical concept of the invention, including a combination of individual technical features in any other suitable manner, such simple modifications and combinations thereof shall also be regarded as the content disclosed by the invention, each of them falls into the protection scope of the invention.

1-18. (canceled)

19. A separation membrane includes a base material layer, a porous support layer, a polyamide layer, and a modification layer in sequence;
wherein the cross-linked polymers forming the modification layer comprise structural units provided by polyphenols and structural units provided by polyamines, at least some of the structural units provided by the polyphenols connecting with the polyamide layer via ortho-positions of phenolic hydroxyl groups;
wherein a pore size of the separation membrane is within a range of 0.1-0.5 nm, and a surface Zeta potential of the separation membrane is within a range from −5 mV to 30 mV.

20. The separation membrane according to claim 19, wherein the pore size of the separation membrane is within a range of 0.15-0.3 nm, and the surface Zeta potential of the separation membrane within a range from 1 mV to 10 mV.

21. The separation membrane according to claim 19, wherein the modification layer comprises the structural units shown in formula I;

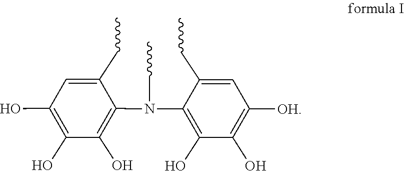

22. The separation membrane according to claim 19, wherein a content of the structural units provided by polyphenols at the membrane surface is within a range of 2×10⁻³-5×10⁻² mg/cm²;
a content of the structural units provided by polyamines at the membrane surface is within a range of 1×10⁻³-2.5×10⁻² mg/cm².

23. The separation membrane according to claim 22, wherein the content of the structural units provided by polyphenols at the membrane surface is within a range of 2.5×10⁻³-5×10⁻² mg/cm²; the content of the structural units provided by polyamines at the membrane surface is within a range of 4×10⁻³-2×10⁻² mg/cm².

24. The separation membrane according to claim 19, wherein a content of nitrogen atoms in the modification layer is within a range of 13-20 at. %.

25. The separation membrane according to claim 24, wherein the content of nitrogen atoms in the modification layer is within a range of 13.5-18.5 at. %.

26. The separation membrane according to claim 19, wherein a contact angle of the separation membrane is within a range of 20-60°.

27. The separation membrane according to claim 26, wherein the contact angle of the separation membrane is within a range of 20-40°.

28. The separation membrane according to claim 19, wherein the separation membrane has a thickness within a range of 100-200 μm;
and/or, the base material layer has a thickness within a range of 30-150 μm;
and/or, the porous support layer has a thickness within a range of 10-100 μm;
and/or, the polyamide layer has a thickness within a range of 10-500 nm;
and/or, the modification layer has a thickness within a range of 1-200 nm.

29. The separation membrane according to claim 28, wherein the base material layer has the thickness within a range of 50-120 μm;
and/or, the porous support layer has the thickness within a range of 30-60 μm;
and/or, the polyamide layer has the thickness within a range of 50-150 nm;
and/or, the modification layer has the thickness within a range of 10-60 nm.

30. The separation membrane according to claim 19, wherein a material of the base material layer is at least one selected from the group consisting of a polyester nonwoven fabric, a polyethylene nonwoven fabric, and a polypropylene nonwoven fabric;
and/or, a material of the porous support layer is at least one selected from the group consisting of polyether sulfone, polysulfone, polyaromatic ether, polybenzimidazole, polyether ketone, polyether ether ketone, polyacrylonitrile, polyvinylidene fluoride, and polyaryletherketone.

31. The separation membrane according to claim 19, wherein the polyamide layer is produced from the synthesis of polyamines and polyacyl chloride;
and/or, the polyamines are at least one selected from the group consisting of polyethyleneimine, triethylene tetramine, tetraethylene pentamine, diethylene triamine, piperazine, m-phenylenediamine, and p-phenylenediamine;
and/or, the polyacyl chloride is at least one selected from the group consisting of trimesoyl chloride, terephthaloyl chloride, isophthaloyl chloride, and phthaloyl chloride.

32. The separation membrane according to claim 31, wherein the polyamines are at least one of polyethyleneimine, piperazine, and polyethylene polyamine;
and/or, the polyacyl chloride is at least one of trimesoyl chloride and terephthaloyl chloride.

33. The separation membrane according to claim 19, wherein the modification layer is obtained through a self-assembly reaction of polyphenols and polyamines on a polyamide layer;
and/or, the polyphenols are one or more selected from the group consisting of tannic acid, tea polyphenol, gallic acid, catechuic acid, lignin, sodium lignosulfonate, apple polyphenol, grape polyphenol, eriodictyol, naringenin, epicatechin, luteolin, apigenin, kaempferol, myricetin, and genistein;
and/or, the polyamines are at least one selected from the group consisting of polyethyleneimine, tetraethylene pentamine, triethylene tetramine, and polyethylene polyamine.

34. The separation membrane according to claim 33, wherein the polyphenols are tannic acid and/or tea polyphenol.

35. A method for preparing the separation membrane includes: sequentially preparing the porous support layer, the polyamide layer, and the modification layer on the base material layer; wherein a method for preparing the modification layer includes: under a first pressure, and under conditions in which a polyphenol solution remains fluid, subjecting the polyamide layer side of a material including a base material layer, a porous support layer and a polyamide layer to a first contact with the polyphenol solution; then under a second pressure, and under conditions in which a polyamine solution remains fluid, subjecting the polyamide layer side of the material to a second contact with the polyamine solution to complete a self-assembly reaction.

36. The method according to claim 35, wherein the first pressure and the second pressure are each independently within a range of 0.1-1.2 MPa;
and/or, the polyphenol solution and the polyamine solution are used in an amount such that a mass ratio of the polyphenols to the polyamines is within a range of (0.1-10): 1;
and/or, a concentration of the polyphenol solution is within a range of 0.00001-1 wt %;
and/or, a concentration of the polyamine solution is within a range of 0.00001-1 wt %.

37. The method according to claim 36, wherein the first pressure and the second pressure are each independently within a range of 0.2-1 MPa;
and/or, the polyphenol solution and the polyamine solution are used in an amount such that a mass ratio of the polyphenols to the polyamines is within a range of (0.2-6): 1;
and/or, the concentration of the polyphenol solution is within a range of 0.0001-0.1 wt %;
and/or, the concentration of the polyamine solution is within a range of 0.0001-0.1 wt %.

38. The method according to claim 35 wherein temperatures of the first contact and the second contact are each independently within a range of 10-30° C.;
and/or, in one self-assembly reaction, time of the first contact is within a range of 1-120 min;
and/or, in one self-assembly reaction, time of the second contact is within a range of 1-120 min;
and/or, number of self-assembly reactions is within a range of 1-10;
and/or, conditions for preparing the modification layer comprise such that the thickness of the modification layer in the separation membrane is within a range of 1-200 nm.

39. The method according to claim 38, wherein in one self-assembly reaction, time of the first contact is within a range of 10-60 min;
and/or, in one self-assembly reaction, time of the second contact is within a range of 10-60 min;
and/or, number of self-assembly reactions is within a range of 2-5;
and/or, conditions for preparing the modification layer comprise such that the thickness of the modification layer in the separation membrane is within a range of 10-60 nm.

40. The method according to claim 35, wherein polyphenols in the polyphenol solution are one or more selected from the group consisting of tannic acid, tea polyphenol, gallic acid, catechuic acid, lignin, sodium lignosulfonate, apple polyphenol, grape polyphenol, eriodictyol, naringenin, epicatechin, luteolin, apigenin, kaempferol, myricetin, and genistein;
and/or, polyamines in the polyamine solution are at least one selected from the group consisting of polyethyleneimine, tetraethylene pentamine, triethylene tetramine, and polyethylene polyamine.

41. The method according to claim 40, wherein polyphenols in the polyphenol solution are tannic acid and/or tea polyphenol.

42. The method according to claim 35, wherein the method for preparing the porous support layer include:
coating a solution containing the porous support layer material on a base material layer, and performing a phase transformation to obtain a material containing the base material layer and the porous support layer.

43. The method according to claim 42, wherein conditions for the phase transformation include: soaking in water of 10-30° C. for 10-60 min;
and/or, a thickness of the base material layer is within a range of 30-150 μm;
and/or, the base material layer material is at least one selected from the group consisting of a polyester nonwoven fabric, a polyethylene nonwoven fabric, and a polypropylene nonwoven fabric;
and/or, conditions for preparing the porous support layer include such that a thickness of the porous support layer in the separation membrane is within a range of 10-100 μm;
and/or, a concentration of the solution containing the porous support layer material is within a range of 10-20 wt %;
and/or, the porous support layer material is at least one selected from the group consisting of polyether sulfone, polysulfone, polyaromatic ether, polybenzimidazole, polyether ketone, polyether ether ketone, polyacrylonitrile, polyvinylidene fluoride, and polyaryletherketone;
and/or, solvent in the solution including the porous support layer material is at least one selected from the group consisting of N,N-dimethylformamide, N,N-dimethylacetamide, N-methylpyrrolidone, and dimethylsulfoxide.

44. The method according to claim 43, wherein the thickness of the base material layer is within a range of 50-120 μm;
and/or, conditions for preparing the porous support layer include such that the thickness of the porous support layer in the separation membrane is within a range of 30-60 μm.

45. The method according to claim 35, wherein the method for preparing the polyamide layer includes: subjecting a porous support layer surface of a material including the base material layer and the porous support layer sequentially with an aqueous phase including polyamines and an organic phase including polyacyl chloride, then performing a thermal treatment.

46. The method according to claim 45, wherein conditions for preparing the polyamide layer include such that a thickness of the polyamide layer in the separation membrane is within a range of 10-500 nm;
and/or, time of contacting the porous support layer surface with an aqueous phase including polyamines is within a range of 5-100 s;
and/or, time of contacting the porous support layer surface with an organic phase including polyacyl chloride is within a range of 10-200 s;
and/or, the aqueous phase including polyamines and the organic phase including the polyacyl chloride are used in an amount such that the mass ratio of the polyamines to the polyacyl chloride is within a range of (0.1-10): 1;
and/or, a concentration of the aqueous phase including polyamines is within a range of 0.1-10 wt %;
and/or, a concentration of the organic phase including polyacyl chloride is within a range of 0.01-1 wt %;
and/or, the polyamines are at least one selected from the group consisting of polyethyleneimine, triethylene tetramine, tetraethylene pentamine, diethylene triamine, piperazine, m-phenylenediamine, and p-phenylenediamine;
and/or, the polyacyl chloride is at least one selected from the group consisting of trimesoyl chloride, terephthaloyl chloride, isophthaloyl chloride, and phthaloyl chloride;
and/or, temperature of the thermal treatment is within a range of 40-150° C.; time of the thermal treatment is within a range of 0.5-10 min.

47. The method according to claim 46, wherein conditions for preparing the polyamide layer include such that the thickness of the polyamide layer in the separation membrane is within a range of 50-300 nm;
and/or, time of contacting the porous support layer surface with an aqueous phase including polyamines is within a range of 10-60 s;
and/or, time of contacting the porous support layer surface with an organic phase including polyacyl chloride is within a range of 20-120 s;
and/or, the aqueous phase including polyamines and the organic phase including the polyacyl chloride are used in an amount such that the mass ratio of the polyamines to the polyacyl chloride is within a range of (0.5-8): 1;
and/or, the concentration of the aqueous phase including polyamines is within a range of 0.5-2.5 wt %;
and/or, the concentration of the organic phase including polyacyl chloride is within a range of 0.1-0.5 wt %;
and/or, the polyamines are at least one of polyethyleneimine, piperazine, and polyethylene polyamine;
and/or, the polyacyl chloride is at least one of trimesoyl chloride and terephthaloyl chloride;
and/or, temperature of the thermal treatment is within a range of 50-120° C.; time of the thermal treatment is within a range of 1-5 min.

48. A method of using the separation membrane according to claim 19 in the magnesium-lithium separation.
